(19) United States
(12) Patent Application Publication
(10) Pub. No.: US 2013/0013676 A1
(43) Pub. Date: Jan. 10, 2013

(54) METHOD AND SYSTEM FOR CONTINUOUS INTERACTIVE COMMUNICATION IN AN ELECTRONIC NETWORK

(75) Inventors: John Blair, San Francisco, CA (US); Robert Pasker, San Francisco, CA (US)

(73) Assignee: PUVAAL APPLICATIONS AG, LLC, Dover, DE (US)

(21) Appl. No.: 13/619,909

(22) Filed: Sep. 14, 2012

Related U.S. Application Data
(63) Continuation of application No. 09/922,337, filed on Aug. 3, 2001.
Application No. 09/922,337 is a continuation-in-part of application No. 09/896,017, filed on Jun. 28, 2001, now Pat. No. 7,155,477.

(51) Int. Cl. G06F 15/16

(52) U.S. Cl. 709/203

(57) ABSTRACT

A method and system are disclosed for providing continuous, interactive communication among devices on an electronic network (110). Message storage is provided for allowing messages to be stored (166,178) while the client is offline or otherwise unavailable. The method and system is operable with any addressable device (164, 174, 174) on the electronic network. The communication method and system according to the present invention use a graphical user interface to virtually represent the applications that are used to interact with the electronic network. These graphical representations (276) are used to facilitate the transmission and receipt of messages across the electronic network. Applications according to the present invention are grouped into different levels according to their increasing levels of power and specificity. An interface (384, 472) is also provided to iconically represent the underlying interactive connections of the communication system.

### CROSS-REFERENCE TO RELATED APPLICATIONS

This application is a continuation of U.S. application Ser. No. 09/922,337, filed Aug. 3, 2001 and entitled “MESSAGE DELIVERY SYSTEM BILLING METHOD AND APPARATUS,” which is a continuation-in-part of U.S. application Ser. No. 09/896,017, filed Jun. 28, 2001, now U.S. Pat. No. 7,155,477 and entitled “METHOD AND SYSTEM FOR CONTINUOUS INTERACTIVE COMMUNICATION IN AN ELECTRONIC NETWORK,” which claims priority from International Patent Application PCT/US2000/032246, filed Nov. 22, 2000 and entitled METHOD AND SYSTEM FOR CONTINUOUS INTERACTIVE COMMUNICATION IN AN ELECTRONIC NETWORK, which claims the benefit of U.S. Provisional Application No. 60/167,458, filed Nov. 24, 1999, each of which is hereby expressly incorporated by reference in their entireties.

### BACKGROUND

1. Field of the Invention

The present invention relates generally to a method and system for providing continuous communication in an electronic network. Specifically, the invention is a method and system for bi-directional communication that enables and facilitates the creation and use of interactive Internet applications.

2. Description of the Related Art

The use of the Internet and other electronic networks has resulted in an increasing shift from software applications designed to run on client computers to server-based applications that are accessible to the client computers of the electronic network. A typical prior art method for a client computer to interact with such server-based applications is through use of a Web browser application. A Web browser application enables the client computer to make requests to and receive responses from the server.

FIG. 1 is a system diagram illustrating the Internet-based communication according to the prior art. In the traditional model, a browser application operable on a client device 14 is used to communicate across the electronic network, such as the World Wide Web (“Web”) 10.

The browser application is used to permit the client device to communicate with a Web site 12. In this prior art model, the user is limited to contact with the selected active Web site. Furthermore, such contact can only be initiated and maintained during the actual visit to the Web site, referred to as a “session” 16. This traditional model requires substantial device capabilities and has therefore been limited to computers and certain other devices such as Internet-capable telephones and personal digital assistants.

FIG. 2 is a graphical user interface illustrating a standard network-delivered service according to the prior art. In the prior art, a browser 20 provides a window 22 in which content from a web site is displayed. Browser applications, however, can be prone to data transmission errors. Furthermore, slow connection speeds between the client device and the Web site server can result in an unsatisfactory user experience.

The prior art browser mode is subject to several additional significant limitations. First, the prior art browser model is unidirectional. Thus, while the client computer can make a request to the server and the server can respond, the server cannot, in turn, make a request to the client computer and receive a corresponding response.

Second, if the browser application is not directed to the site at which the desired the network service is located, interaction between the client and the site is terminated. Thus, communication is not continuously maintained, for example, if the browser application is closed. In addition, it can be difficult to control the allocation of bandwidth and processor capacity in the prior art model. As a result, available processor capacity for other applications running on the client computer can be severely restricted or interrupted, for example when the client device is downloading a large file.

It would therefore be an advantage to provide a method and system for bi-directionally connecting a network-based application to a client device. It would be a further advantage if this method and system provided a persistent connection to a site while the client device is in communication with the electronic network, and not just when the client is browsing at the site. It would be yet another advantage if such method and system were available to all addressable devices on an electronic network.

### SUMMARY

The present invention is a method and system for providing continuous, interactive communication among devices on an electronic network. The invention provides a permanent, dedicated connection between a server application and a client device. This connection persists during the entire time the client device is in communication with the electronic network.

The connection according to the present invention is symmetric and bi-directional. Thus, both client and server can initiate communication, requests, conversations, and transactions. In addition, the method and system according to the present invention is operable with any addressable device on the electronic network. The invention can be used as an alternative to, or in conjunction with, prior art electronic network communication methods such as Web browsers, file transfer protocol applications, e-mail applications, and data streaming applications.

The present invention also implements an advanced message routing system. This message routing system supports such features as device-level addressing, typed data, and publish/subscribe message distribution. The message routing system also supports addressing to a user, group of users, topic, device or application.

The present invention includes a set of base capabilities that are built on top of the message routing system. These base capabilities can include client presentation and interaction capabilities, message management capabilities, and the provision and management of a data storage area on the device for each Internet application.

The preferred embodiment of the present invention includes a bi-directional communications channel through the Internet from an Internet application to a client device. Storage is provided within the bi-directional communications channel for allowing messages to be stored while the client is offline or otherwise unavailable. An Internet management system is used to allow Internet applications to create, delete, and manage messages, users, permissions and all other aspects of the system configuration. Gateways are used to connect the Internet management system to addressable but not internetworked devices, e.g. faxes and Web pages that are not on the network, but that are reachable through electronic or other communication means.

Storage is also provided on the client device for allowing messages to be stored while the client is offline or otherwise unavailable. In addition, a user management system allows the user to create, delete, and manage streams, users, permissions and all other aspects of the system and client configuration.

In the preferred embodiment, a communication system server application sends messages to, and receives messages from, application elements in communication with the electronic network, such as network application providers and clients. The communication system server functions as a multiplexer and demultiplexer by routing each of the messages received from different sources on the electronic network to its intended destination(s). The communication system therefore provides one or more private communications channels between any two or more application elements on the electronic network.

In the preferred embodiment, the communication system server sends and receives messages from a dedicated software module that is located on the client device. The dedicated client software module manages all aspects of the present invention on the client that are necessary for the function of the invention, including but not limited to mediating messages between the client and the communications server, managing the installation of new applications that will use the present invention, setting and changing preferences and rules, and deleting messages.

The invention supports sub-addressing within an individual address. Sub-addressing permits messages to be directed to particular devices or applications, such as a personal digital assistant, cell phone, fax machine, answering machine, desktop computer, laptop computer, as well as for any other type of device that is capable of being connected to the electronic network.

The communication system according to the present invention uses a graphical user interface, referred to as a NetButton, to facilitate the transmission and receipt of messages across the electronic network. In the preferred embodiment, NetButtons virtually represent the applications that are used to interact with the electronic network. For example, in one embodiment, a NetButton can be used to graphically represent a particular topic. The user can manipulate this topic using the NetButton. A NetButton can be represented as a message and can therefore be transmitted to other devices on the electronic network.

In the preferred embodiment of the present invention, a user's desktop graphical user display includes a message window that lists the messages that have been received by the user or subscriptions for which the user is enrolled. These messages can include any objects including but not limited to NetButtons, text or graphical messages, or application data.

An application display window displays a list of addresses on the electronic network. These addresses can be displayed, for example, as a text list, icons, or NetButtons. Thus, it is possible to display an icon for an individual, for a group of individuals, or for a device such as a fax machine.

A NetButton in the application display window can be selected by any well-known method, such as by clicking on the NetButton graphical representation. Applications and messages can be dragged between the application display window and the message window. Thus, messages including but not limited to URLs, audio files, and graphic images can be dragged onto these NetButtons. The application associated with the respective message type and NetButton is thereby performed. NetButtons can be stored on the user's client device, or in any networked location accessible to that client device.

A user can select an object from window and drag the object to an address in the second window. The object will then be transmitted to the selected address. Alternatively, the object can be dragged onto an address representing a device, such as a fax machine. In this case, the object will be sent directly to the selected fax machine. Subscriptions, for example to interest groups, can be similarly transmitted.

In the presently preferred embodiment, applications are grouped into four different levels according to their increasing levels of power and specificity. A Level Zero application places no application-specific code on the client and is implemented solely on the application provider's server. Messages are sent by that server and accessed or displayed on the client using the present invention. A Level One application places some code on the client and uses user input services provided by the present invention to allow the user to initiate, and to respond to, information and transactions. In a Level Two application, the application provider creates application software that is operable on the user's device and that communicates with corresponding software on the application server using the present invention. A Level Three application is a stand-alone application that runs on the client separately from the communication system software but uses the communications system.

One feature provided in the preferred embodiment of the present invention is an interface to the underlying interactive connections of the communication system. This interface, referred to as a “TubeTop” is an iconic representation of a permanent connection, referred to as a “Tube”, to at least one other address on the electronic network. The present invention provides two types of basic connectivity capabilities—a one-to-one connection for bi-directionally publishing and receiving messages, and a one-to-many connection.

The TubeTops according to the present invention can be used to represent with icons or NetButtons any individual person, groups of people, or device on the electronic network. These icons or NetButtons represent the ability to send information to or receive information from the respective people, topics, or devices through the communication system. The TubeTop is essentially a defined standard interface sitting “on top” of a Tube and that leverages all of the Tube's abilities to enable appliance-like applications to interact and deliver any kind of focused functionality

The TubeTop feature according to the present invention can readily be used to facilitate topic-based communication. In addition, the TubeTop feature can be used as an interface to particular functions or services. When a TubeTop NetButton is selected, an application window appropriate to the respective NetButton opens. The Tube delivery feature can be used to transfer information directly to a file or to an application.

Tube connection according to the present invention can be used, for example, to permit users to build and share mutual collections of files. The Tube delivery feature can also be used to share information. Another type of TubeTop is as application that can be used to create and transmit information to a selected person or device on the electronic network.

### BRIEF DESCRIPTION OF THE DRAWINGS

FIG. 1 is a system diagram illustrating the Internet-based communication according to the prior art.

FIG. 2 is a graphical user interface illustrating a standard network-delivered service according to the prior art.

FIG. 3 is a block diagram of a computer network system according to one embodiment of the present invention.

FIG. 4 is a system diagram showing software and system components according to the preferred embodiment of the present invention.

FIG. 5 is a system diagram illustrating Internet-based communication according to the present invention.

FIG. 6 is a system diagram illustrating the method for continuous, interactive communication according to the preferred embodiment of the present invention.

FIG. 7 is a diagram illustrating the interaction of the invention with the prior art web browser model.

FIG. 8 is a graphical user interface illustrating a level zero application showing off-line information access according to one embodiment of the present invention.

FIG. 9 is a graphical user interface illustrating a Level One application showing symmetric event driven communication according to one embodiment of the present invention.

FIG. 10 is a graphical user interface illustrating symmetric event driven communication for non-PC devices according to one embodiment of the present invention.

FIG. 11 is a graphical user interface illustrating integration of a Level One application according to the present invention with a networked prior art message service application.

FIG. 12 is a graphical user interface illustrating integration of a Level One application according to the present invention with a networked calendaring service application.

FIG. 13 is a graphical user interface illustrating a Level One NetButton according to the present invention.

FIG. 14 is a graphical user interface illustrating integration of a Level Two application according to the present invention with a web site.

FIG. 15 is a graphical user interface illustrating a Level Two application for a client-driven transaction according to the present invention.

FIG. 16 is a graphical user interface illustrating a response to a client-driven transaction using a Level Two application according to the present invention.

FIG. 17 is a graphical user interface illustrating integration of a Level Two application according to the present invention with a networked prior art message service application. 1,

FIG. 18 is an eCommerce sales merchandising system according to the present invention.

FIG. 19 is an eCommerce sales merchandising system according to the present invention.

FIG. 20 is a graphic user interface display illustrating Tube connection according to the present invention.

FIG. 21 is a graphic user interface display illustrating Tube connection with intuitive, device-level addressing according to the present invention.

FIG. 22 is a graphic user interface display illustrating personalized Tube connection according to the present invention.

FIG. 23 is a graphic user interface displaying one-to-many communications using a Tube connection according to the present invention.

FIG. 24 is a graphic user interface display showing moderated personalized Tube connection according to the present invention.

FIG. 25 is a graphic user interface display showing communication of an application created according to the present invention.

FIG. 26 is a graphic user interface display showing communication of an application created according to the present invention.

FIG. 27 is a system diagram illustrating communication among applications on a processing device according to the present invention.

FIG. 28 is a system diagram illustrating an example of broker-mediated communication among applications according to the preferred embodiment of the present invention.

FIG. 29A illustrates a switching network according to one embodiment of the present invention that couples a data object content provider (publisher) to a customer client computer, or user (subscriber).

FIG. 29B illustrates a switching network according to one embodiment of the present invention that couples a data object content provider (publisher) to a plurality of customer client computers, or users (subscribers).

FIG. 29C illustrates a switching network according to one embodiment of the present invention that couples a plurality of data object content providers (publishers) to a plurality of customer client computers, or users (subscribers).

FIG. 29D illustrates a switching network according to one embodiment of the present invention that couples a plurality of data object content providers (publishers) to a plurality of customer client computers, or users (subscribers) through an intermediate server.

FIG. 29E illustrates a switching network according to one embodiment of the present invention that couples a plurality of data object content providers (publishers) to a plurality of customer client computers, or users (subscribers) in which one or more of the subscribers may be coupled to a variety of client devices.

FIG. 30 is a block diagram of a computer network system that can be used to implement a data object delivery and billing system, according to one embodiment of the present invention.

FIG. 31A illustrates a communications platform based client server network system for continuous interactive communications that can be used to implement a data object delivery and billing system, according to one embodiment of the present invention.

FIG. 31B illustrates a communications platform based client server network system for continuous interactive communication that can be used to implement a data object delivery and billing system, according to an alternative embodiment of the present invention.

FIG. 32 is a flow diagram that illustrates the publisher, or data object content provider-side process for the electronic commerce system of FIG. 29, according to one embodiment of the present invention.

FIG. 33 is a flow diagram that illustrates the subscriber or user-side process for the electronic commerce system of FIG. 29, according to one embodiment of the present invention.

FIG. 34 illustrates a network architecture for continuous interactive communication that implements a content delivery and billing system, according to one embodiment of the present invention.

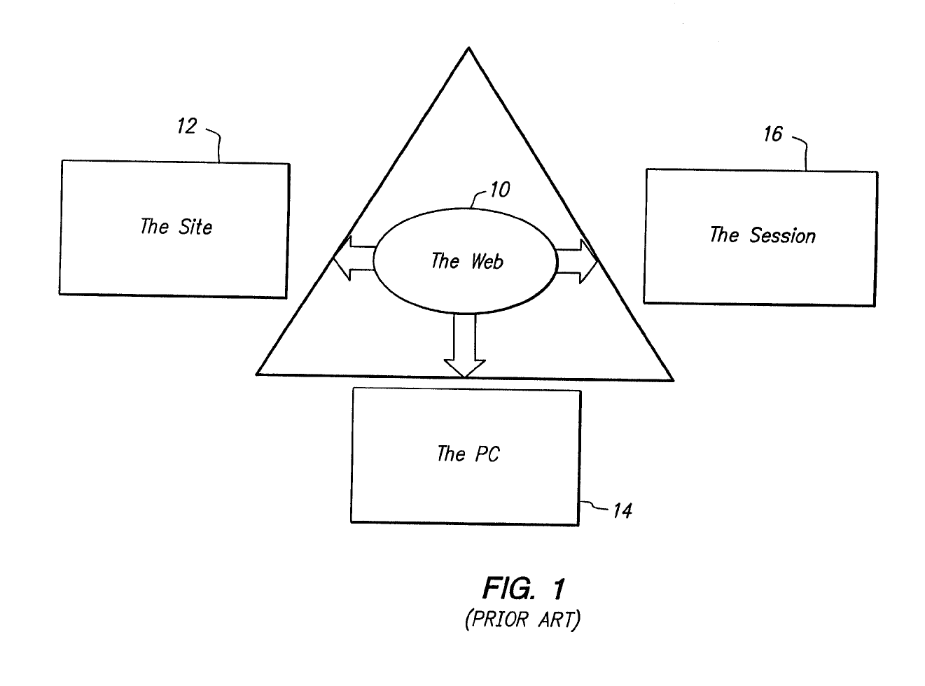

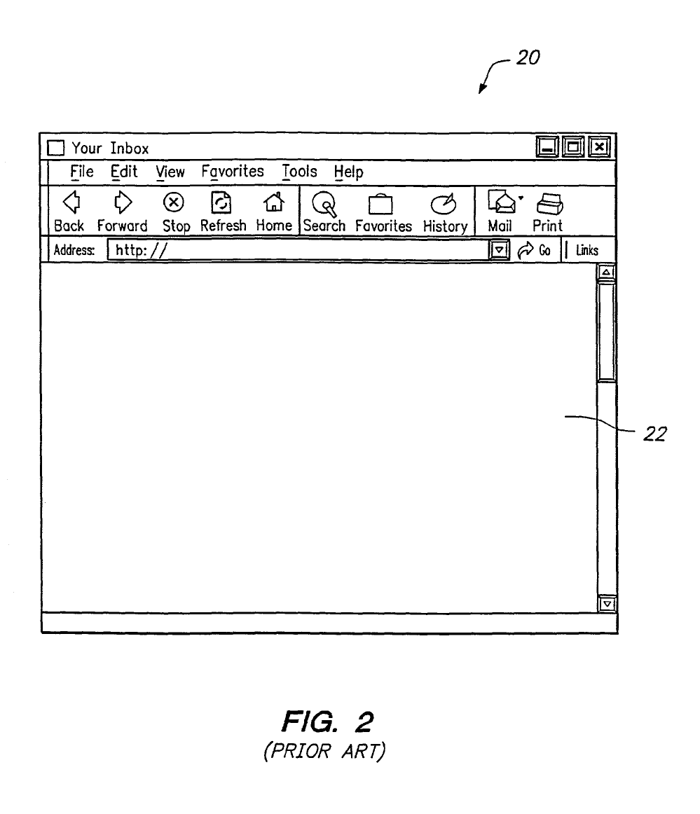

### DETAILED DESCRIPTION

The present invention is a method and system for continuous, interactive communication across an electronic network such as the Internet, a wide-area network, or a local area network. In particular, the invention can be used as an alternative to, or in conjunction with, prior art electronic network communication methods such as Web browsers, file transfer protocol applications, e-mail applications, and data streaming applications. The present invention can be used with any device that can be connected to the electronic network, including but not limited to a server computer, personal computer, network computer, dumb terminal, personal digital assistant (“PDA”), pager, Internet-capable telephone, global positioning device, and fax machine.

In the following description, for purposes of explanation, numerous specific details are set forth in order to provide a thorough understanding of the present invention. It will be evident, however, to one skilled in the art that the present invention may be practiced without the specific details. In other instances, well-known structures and devices are shown in block diagram form to facilitate explanation. The description of preferred embodiments is not intended to limit the scope of the claims appended hereto. In one embodiment, the present invention is implemented using a computer. Such computer can include but is not limited to a personal computer, network computer, network server computer, dumb terminal, local area network, wide area network, personal digital assistant, work station, minicomputer, and mainframe computer. The identification, search and/or comparison features of the present invention can be implemented as one or more software applications, software modules, firmware such as a programmable ROM or EEPROM, hardware such as an application-specific integrated circuit (“ASIC”), or any combination of the above.

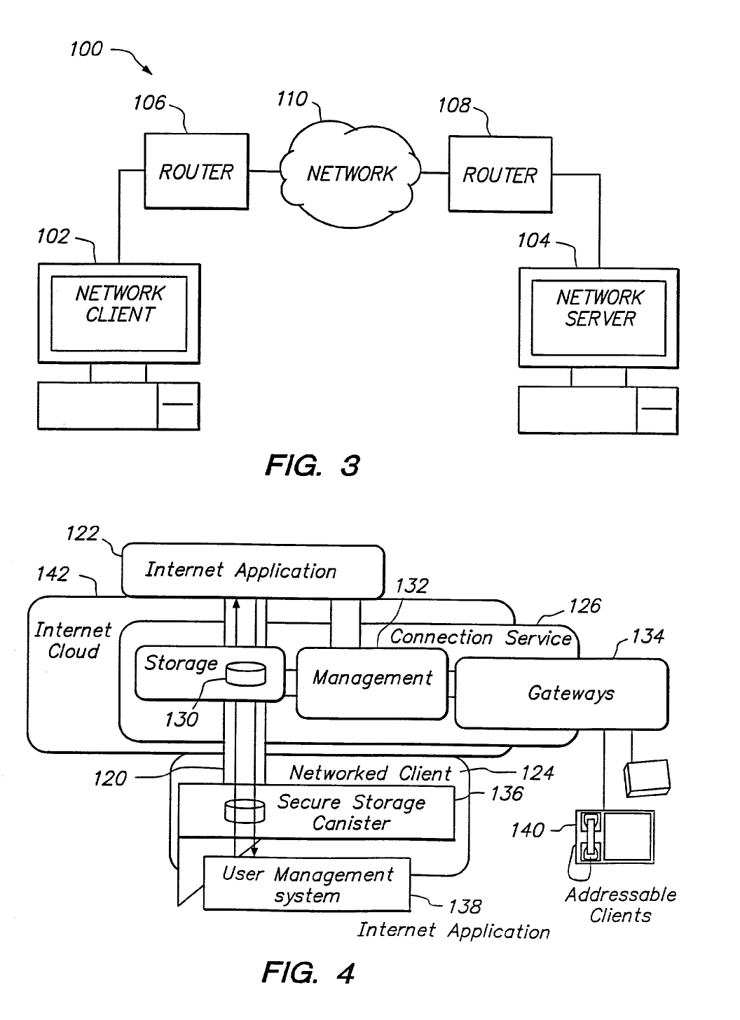

FIG. 3 is a block diagram of a computer network system 100 according to one embodiment of the present invention. In computer network system 100, a network server computer 104 is connected to a network client computer 102 through a network 110. The network interface between server computer 104 and client computer 102 can also include one or more routers, such as routers 106 and 108. The routers serve to buffer and route the data transmitted between the server and client computers. Network 110 may be the Internet, a Wide Area Network (WAN), a Local Area Network (LAN), or any combination thereof. In one embodiment of the present invention, the server computer 104 is a World-Wide Web (WWW) server that stores data in the form of ‘web pages’ and transmits these pages as Hypertext Markup Language (HTML) files over the Internet network 110 to client computer 102. It should be noted that, although only one server and client computer each are illustrated in network system 100, a network that implements embodiments of the present invention may include a large number of interconnected client and server computers.

The present invention also uses one or more software applications accessible to the client device and/or server computers to permit continuous, interactive communication across an electronic network. Any or all of the software applications or hardware configurations of the present invention can be implemented by one skilled in the art using well known programming techniques and hardware components.

The present invention implements an advanced message routing system. This message routing system, described below in further detail, supports such features as device-level addressing, typed data, and publish/subscribe message distribution. The message routing system also supports addressing to a user, group of users, topic, device or application.

The communication system service according to the preferred embodiment also includes a set of base capabilities that are built on top of the message switch. For example, electronic commerce (“eCommerce”) businesses as well as other users of the present invention are provided with a set of client presentation and interaction capabilities. Rather than just providing the ability to transfer and to receive data, messages, or objects, the present invention also enables and facilitates the creation of interactive Internet applications to present information to a user and to receive information in return.

Another base service provided in the present invention is message management. For example, a user of the present invention can configure such features as the maximum lifetime of a message, redelivery permissions, and content management. This permits, for example, an eCommerce business to send a time-limited product to a user. The product expires within a designated time unless the user buys the product.

Yet another base service provided in the present invention is the provision and management of a data storage area on the device for each Internet application. This storage area allows the application to reliably store its own status information for its own purposes, for example to manage and update the application's code, or to store data for the next time the application is used.

In the following description, for purposes of explanation, numerous specific details are set forth in order to provide a thorough understanding of the present invention. It will be evident, however, to one skilled in the art that the present invention may be practiced without the specific details. In other instances, well-known structures and devices are shown in block diagram form to facilitate explanation. The description of preferred embodiments is not intended to limit the scope of the claims appended hereto. An Internet application is software whose component parts may reside partly or wholly on the server or the user's computer or other networked or addressable device. Communication between the component parts of the application occurs across the Internet.

FIG. 4 is a system diagram showing software and system components according to the preferred embodiment of the present invention. The components of the present invention include: A bi-directional communications channel 120 through the Internet 142 from an Internet application 122 to a client device 124. In the preferred embodiment of the invention this channel is provided by a network service 126. In alternative embodiments, the channel can be provided through software on the Internet application's server that connects directly to the client device. Storage 130 within the bi-directional communications channel that allows messages to be stored while the client is offline or otherwise unavailable. In the preferred embodiment of the invention this storage is provided within the network service, but in alternative embodiments it can be provided on the Internet application's server. An Internet management system 132 that allows Internet applications to create, delete, and manage messages, users, permissions and all other aspects of the system configuration. In the preferred embodiment of the invention, the Internet management system is provided within the network service, but in alternative embodiments it may be provided on the Internet application's server. Gateways 134 that connect the management service to addressable but not internetworked devices 140, e.g. faxes and pages that are not on the network, but are reachable through electronic or other communication means. Storage 136 on the client device that allows messages to be stored while the client is off-line or the otherwise unavailable. In the preferred embodiment of the invention, this storage is provided on some storage device local to or network-accessible from the client. Storage (not shown) for application state on the client. A user management system 138 that allows the user to create, delete, and manage streams, users, permissions and all other aspects of the system and client configuration. In the preferred embodiment of the invention, the user management system is provided locally on the client and within the network service. In alternative embodiments, the user management system can be provided at any other convenient location such as a Web site.

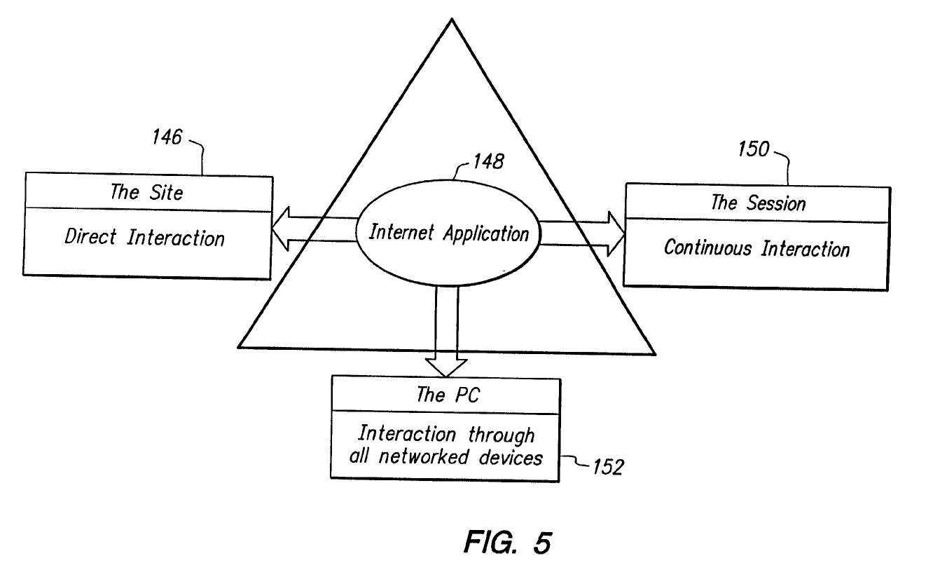

FIG. 5 is a system diagram illustrating Internet-based communication according to the present invention. The present invention overcomes the inherent limitations of the prior art by permitting direct interaction 146 between an Internet application and a client, rather than indirect interaction through a Web server. Continuous connection 150 can thereby be provided with the Internet application 148, rather than the prior art connection only during the time that there is a browser connection to the particular Web server or site. Because a browser is optional, any type of network device 152 can be used to interact with devices connected to the Web.

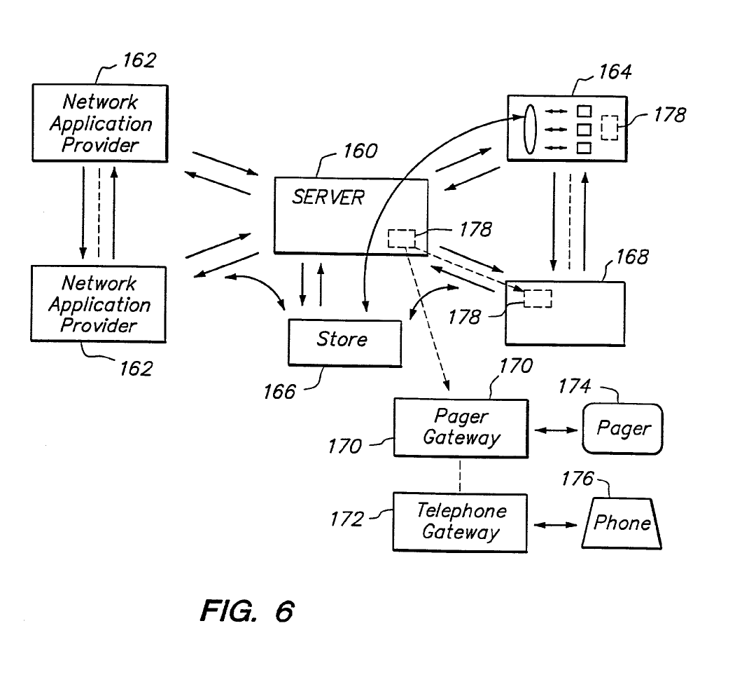

FIG. 6 is a system diagram illustrating the method for continuous, interactive communication according to the preferred embodiment of the present invention. In the preferred embodiment, the communication system server 160 functions as a “funnel” to route, multiplex, demultiplex, and redistribute the electronic communications traffic among the elements of the applications using the present invention. The communication system server can comprise one or more server computers, personal computers, computer networks, and networked devices.

In the preferred embodiment, the communication system server sends messages to, and receives messages from, application elements in communication with the electronic network, such as network application providers 162 and clients 164. The communication system server functions as a multiplexer and demultiplexer by routing each of the messages received from different sources on the electronic network to its intended destination(s). The communication system therefore provides one or more private communications channels between any two or more application elements on the electronic network.

In the preferred embodiment, the communication system server sends and receives messages from a dedicated software platform that is located on the client and is a part of the present invention. The dedicated software platform manages all aspects of the present invention on the client that are necessary for the function of the invention. These aspects include but are not limited to: mediating messages between the client and the communications server; managing the installation of new applications that will use the present invention, setting and changing preferences and rules, and deleting messages.

The communication system server stores messages received from the various application elements in a server message store 166 and forwards these messages to the intended destinations. The software-implemented message store is at least one non-volatile storage such as a hard disk drive or a NVRAM memory that is preferably a part of the server, but can alternatively be located on any device that is accessible to the server. The communication system server thus functions as a store-and-forward message switch, providing the system with the ability to accommodate vagaries of connectivity in the network. While the present invention can be implemented with any appropriate electronic network, in the preferred embodiment, it is implemented as an Internet-based service.

In the presently preferred embodiment, the communication system server can provide a guaranteed delivery of a stored messages to the intended destination(s). When a message has been delivered to a client, the communication system server can retain control over the message until the client submits to the system server an electronic indication that confirms receipt and local storage of the message. Thus, the transmitting application or party can be made aware of whether the message was received. This feature is advantageous in electronic commerce because it minimizes the uncertainty as to whether an electronic transaction, such as a credit card purchase made through a Web site, has been completed.

The system according to the preferred embodiment also includes a client message store 178 that is preferably a non-volatile storage that is a part of the client. This client message store is used to store transactions during an off-line process. In alternative embodiments, the client message store can be stored on any device that is accessible to the client. For example, the client message store 178 can be stored on a local server 168 that is accessible to a client network computer 164. In another embodiment, the client message store is located on the system server.

The communication system server also provides the ability for one provider to send a message to one or more destinations, such as users. In turn, these clients are provided the ability to determine the origin of each received message.

In the communication system according to the preferred embodiment of the present invention, all application data that is transmitted through the electronic network is stored in the appropriate message store prior to being delivered to or accessed by the intended destination. This data is therefore accessed locally by the component devices of the communication system. In alternative embodiments, any portion of this data is stored in the appropriate message stores prior to delivery or access.

The system message store according to the preferred embodiment of the present invention is a transactionally safe store. The present invention provides a transactionally safe store on the user's desktop computer or other connected device to support disconnected operation. Thus, because the application data is stored in the message stores for local access, a client does not have to be on-line to access transaction information. For example, a client can initiate and/or respond to an eCommerce transaction regardless of whether the client is on-line by queuing the request or response in the client store.

Furthermore, the invention performs a traffic shaping function that minimizes the effects of receiving or transmitting data on the operation of the user's computer system. For example, when a large quantity of data is waiting to be transmitted to a user when the user goes on-line, this data transmission can occupy system resources to prevent the user from performing other activities. The invention minimizes the effects of such data transmission.

The present invention shapes this traffic by transparently managing the data to regulate any data the system can control so that it doesn't interfere with data over which there is no control. Thus, a user can select the level of bandwidth consumption that is acceptable for a particular transmission or message. For example, the user can elect to have the transmission use the maximum amount of possible bandwidth, to the exclusion of other transmissions. Alternatively, the user can elect for the transmission in the background, consuming a small amount of the available bandwidth.

This traffic shaping function also permits applications to interact with the message store to receive or transmit data when on-line or off-line, and to automatically re-connect when a connection to the electronic network has been prematurely terminated, recommencing the transmission at the point at which it was terminated, without any need to retransmit data. As a result, there is no loss of data to or from the applications.

The present invention implements an advanced message routing system. This message routing system supports user, topic, application, and device level addressing, supports typed data, and a publish/subscribe addressing model. The message routing system also supports addressing to a user or topic, as well as sub-addressing to a device.

In the preferred embodiment of the present invention, each message transmitted through the communication system has a known type that indicates characteristics of the message. For example, a message that is sent to an answering machine can indicate whether it is a voice message or an alphanumeric message. A typed voice message can be stored in the answering machine while a typed alphanumeric message can be stored in an address box that is part of the answering machine.

To route these messages, the present invention also provides an addressing mechanism that allows a message sender to designate the intended recipient of a message. The preferred embodiment supports two general types of addressing directed to individual addresses and topic-based addresses, respectively. A message that is sent to a topic-based address such as an interest-based list server will be delivered to the individual addresses of all members of the selected topic group. Thus, for example, the sender of the message can transmit a message to all destinations that have subscribed to the topic but does not have to know the individual destinations in advance.

Within the individual address, the invention can also have the ability to permit sub-addressing. Sub-addressing permits messages to be directed to particular devices or applications. For example, a user can have separate dedicated sub-addresses for a personal digital assistant, cell phone, fax machine, answering machine, desktop computer, laptop computer, as well as for any other type of device that is capable of being connected to the electronic network. As an example, a message sent to a topic-based address is directed to all individual addresses associated with the selected topic. For each individual address, the message is directed to any of the individual's sub-addresses.

Control over exactly how those messages are distributed to sub-addresses can be controlled by both the sender and the receiver. The sender or the receiver can set up an arbitrary set of rules based on preferences, intrinsic and extrinsic factors and parameters. For example, these rules can be driven by any of the attributes in the message including but not limited to the type, size, sender, and time. The rules can be used to direct, redirect, transform, and process received messages to particular devices or to other individuals.

A rules and filters engine associated with the user's client device(s) is operable to permit the user to set rules and filters and to direct messages accordingly. Filters can be used, for example, to prevent the delivery of low priority messages or messages of a particular type, such as audio files. In the preferred embodiment, a control panel is displayed as a part of a graphical user interface, for example, on a screen display of the user's desktop computer. The rules and filters engine is accessed through this control panel.

A series of gateways 170, 172 are used to permit the communication system to be bi-directionally connected with non-Internet protocol based devices. For example, the communication system can be interfaced with electronic devices such as alphanumeric pagers 174, e-mail pagers, cell phones 176, fax machines, remote controls, kitchen appliances, and virtually any electronic input or output devices for which some form of communications capability can be provided. A voice response gateway can be provided to allow the communication system to use speech synthesizer applications to “read” aloud a user's messages. The voice gateway can also allow the user to respond using such means as a touchpad or voice recognition. The user's response is then delivered by the communications system to its designated destination(s).

The message routing feature according the present invention allows the development and use of applications that can seamlessly and transparently interact over the electronic network. These applications can be incorporated as a part of the communication system software or can be separate from but accessible thereto. The applications can be configured to interact with prior art Web browsers, or other applications.

In one example of message routing according to the present invention, a credit card billing message is transmitted through the communication system to a user. The user can set up rules in the control panel to directly deliver messages of this type to a money management application. As a result, the credit card billing update can be fed directly into the money management application. Today, it must be viewed as an email i.e. in a different application, or it must be attached to an email and manually transferred to the management application by the user.

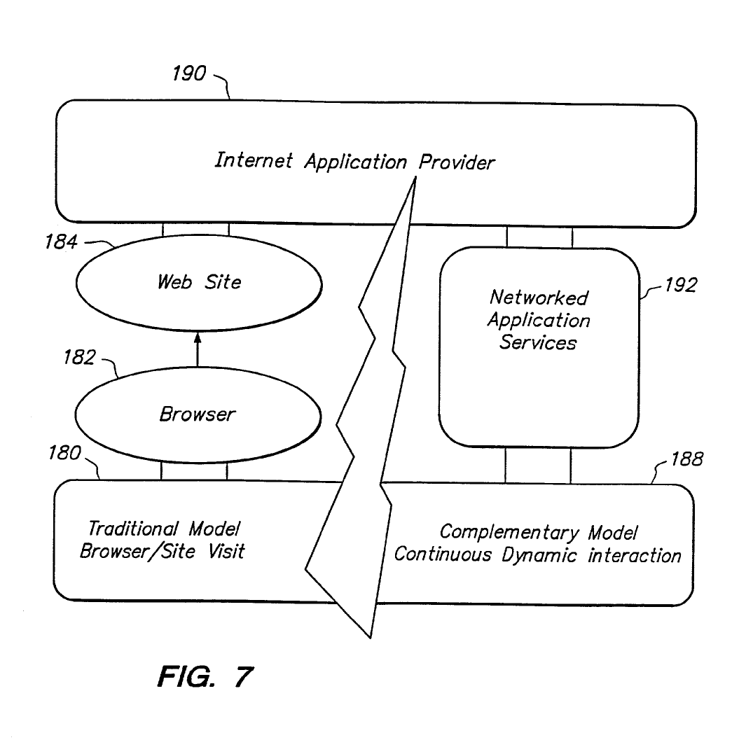

FIG. 7 is a diagram illustrating the interaction of the invention with the prior art web browser model. The traditional model 180 uses a browser 182 to visit a Web site 184. In this model, the user is limited to contact with the selected active Web site. Furthermore, such contact can only be initiated and maintained during the actual visit to the Web site. This traditional model requires substantial device capabilities and has therefore been limited to computers and certain other devices such as Internet-capable telephones and personal digital assistants.

By contrast, the communication system according to the present invention 188 provides a complementary model to the existing Web site browser model to permit continuous direct and dynamic interaction 192 between a Internet application provider 190 and a user. Full integration can be provided between the user and the application. In addition, the communication system according to the present invention does not need the device capabilities required to operate a Web browser. As a result, the present invention is designed to be operable with all networked devices.

In the preferred embodiment, tracking mechanisms are built into the client software platform provided as a part of the present invention. These mechanisms can track such user behaviors as which part of an active window has been selected, which controls have been selected, as well as the number of selections of any designated components of the graphical user display according to the present invention. Therefore, the present invention can be used to accurately track the operations actually performed by users. This information is stored in the communication system message store for eventual delivery to selected entities, such as the Web site applications or market research analysts.

Each message that is passed to the message store is tracked. In the preferred embodiment, the user can determine the permissible level of tracking performed by the client software application. For example, the user can refuse permission to the communication system server for the user's viewing behavior to be tracked. In response thereto, a vendor may elect not to provide the user with a particular product. Different levels of tracking and responses thereto are therefore possible using the present invention.

The communication system according to the present invention uses a novel graphical user interface, herein referred to as a NetButton, to facilitate the transmission and receipt of messages across the electronic network. In the preferred embodiment, NetButtons virtually represent the applications that are used to interact with the electronic network. For example, in one embodiment, a NetButton can be used to graphically represent a particular topic. The user can manipulate this topic using the NetButton. A NetButton can be represented as a message and can therefore be transmitted to other devices on the electronic network.

As an example, a NetButton application can be created to permit the user to directly access a traffic camera picture that is displayed at a Web site. By selecting the NetButton, the traffic camera picture is accessed and displayed to the user. The user can also forward the NetButton to a second user so that this second user can similarly access and view the traffic camera picture.

In the preferred embodiment of the present invention, a user's desktop graphical user display includes a message window that lists the messages that have been received by the user or subscriptions for which the user is enrolled. These messages can include any objects including but not limited to NetButtons, text or graphical messages, or application data. The messages can be displayed by any suitable representation, including but not limited to a text list or icons.

An application display window displays a list of addresses on the electronic network. These addresses can be displayed, for example, as a text list, icons, or NetButtons. Thus, it is possible to display an icon for an individual, for a group of individuals, or for a device such as a fax machine.

A NetButton in the application display window is selected, for example by clicking, to open the application associated with the button. Messages including but not limited to URLs, audio files, and graphic images can be dragged onto these NetButtons. The application associated with the respective message type and NetButton is thereby performed. As an example, a graphic image dragged onto a NetButton for an image converter can be sent over the present invention to an application where it is converted to a different format, returned over the present invention to the sending device and displayed.

NetButtons can be stored on the user's client device, or in any networked location accessible to that client device. NetButtons can therefore be stored in the communications server of the present invention to be accessed by the user on demand.

In the presently preferred embodiment, the application window and message window can use well-known organizational features. For example, objects in these windows can be rearranged, clustered in folders, re-named, and re-sized. Files such as audio files can be associated with particular applications or players. Thus, a sound can be played when a specific NetButton is selected.

A user can select an object in the first window and drag the object to an address in the second window. The object will then be transmitted to the selected address. For example, if the object is a picture or an audio file, it can be transmitted to another person by dragging it onto that person's address or icon. Alternatively, the object can be dragged onto an address representing a device, such as a fax machine. In this case, the object will be sent directly to the selected fax machine.

A subscription can be similarly transmitted. Thus, if a user subscribes to a news service, an object representing the subscription can be selected and dragged onto a second person's address or icon. This second person is thereupon enrolled in the subscription service. In one embodiment of the invention, the object representing the subscription can be displayed to the second person as an invitation to enroll in the subscription. For example, a flashing icon or a sound can indicate the receipt of the object. The second person can then delete the received object, modify it, accept it to enroll in the subscription service, or forward it to yet another person.

In the preferred embodiment, one or more attachments, such as notes or voice messages, can be transmitted with the object. As with any message transmitted according to the present invention, rules and filters can be created and applied.

In the presently preferred embodiment, applications are grouped into four different levels according to their increasing levels of power and specificity. A Level Zero application places no application-specific code on the client—it is implemented solely on the application provider's server; messages are sent by that server using the present invention and accessed or displayed on the client using facilities provided by the present invention. A Level One application places some code on the client, and uses user input services provided by the present invention to allow the user to initiate, and to respond to, information and transactions. In the preferred embodiment of the present invention that code is compliant with the XML specification; however in alternative embodiments other encoding specifications can be used. In a Level Two application, the application provider writes application software that is operable on the user's device; that software communicates with corresponding software on the application server using the present invention. In the preferred embodiment of the invention, that client software will be written for a format native to the client device, such as Windows or Java; however in alternative embodiments any software runtime format would be used. A Level Three application is a stand-alone application that runs on the client separately from the communication system software but uses the communications system.

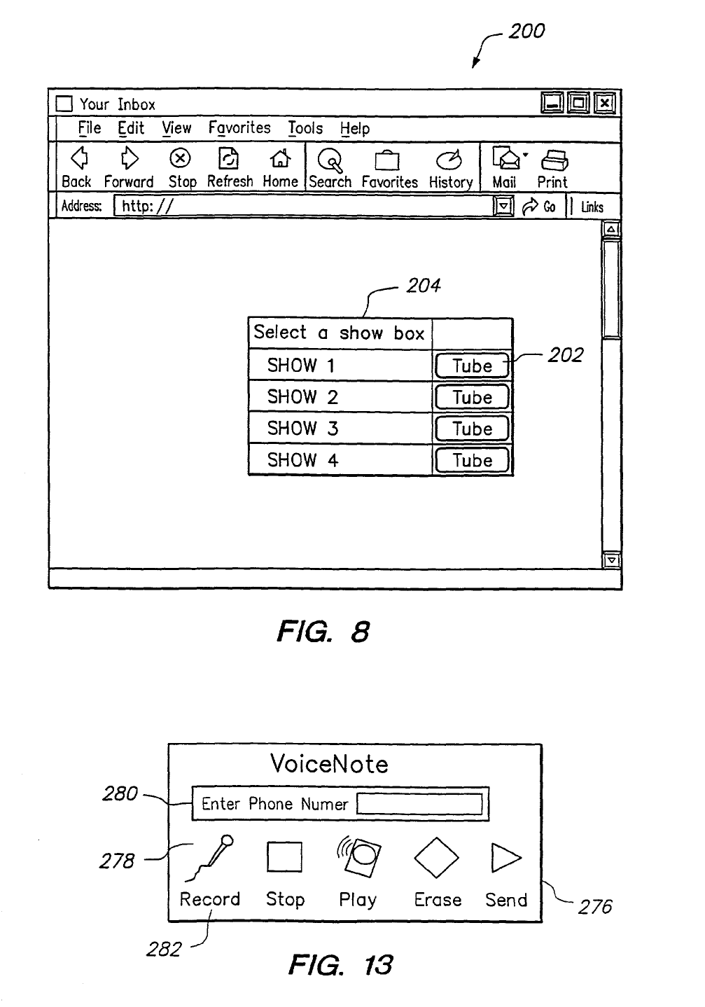

FIG. 8 is a graphical user interface illustrating a level zero application showing offline information access according to one embodiment of the present invention. The FIG. 5 illustrates the asynchronous delivery of content, thereby increasing the speed of user interaction with the site and increasing the utilization of large-content elements such as audio and video. This application is capable of carrying an advertising payload. In addition, full publisher control over the use of content on the client can be maintained, for example by using save and forwarding permissions, or by defining a maximum lifetime of the content.

In the Level Zero application of FIG. 8, the Web page 200 has been modified to include a Tube delivery button 202 associated with each video program available on the Web page. In the embodiment illustrated in FIG. 8, the Web provider is a user of the communication system. The client Web provider is responsible for including the HTML instructions that describe the object (Tube delivery button).

A video can be downloaded and viewed by either selecting the button 204 representing the program, or by selecting the Tube delivery button 202 representing the program. If the program button is selected, the video content is streamed to the user. However, if the user has a slow connection, the quality of the video program may be poor. Furthermore, it may not be possible for the user to save the streamed video content for later viewing.

If the user selects the Tube delivery button, the video program is delivered to the user as a message according to the present invention. This message is delivered according to any rules and filters previously established by the user. The message routing capabilities of the present invention permit this message to be delivered to the user as soon as the user is online sufficiently long (either continuously or cumulatively) to be able to get the program downloaded in its entirety. At that point, the user is able to view, delete, or save the video.

FIG. 9 is a graphical user interface illustrating a Level One application showing symmetric event driven communication according to one embodiment of the present invention. Examples of such applications include but are not limited to a voice speaking accessory, a pager accessory, a graphic image viewer, and an audio file player.

FIG. 9 shows symmetric support for client-driven and server-driven transactions, such as a client-driven switch to a different view or a server-driven update of a client display. A flexible, service-branded user interface can be permitted. In addition, precision user impression and response tracking can be provided.

In the example illustrated in FIG. 9, upon selecting the associated button 210, a Level One stock check application 212 is displayed within a window 222 of the graphical user interface. When the stock check application is selected, a larger window 220 is displayed presenting a constantly-updated view of stock market information from the Web provider. Unlike implementations based upon prior art, applications based on the present information can send such updates instantly as events occur. It is possible to dynamically switch the displayed information—in this example from stock market statistics to portfolio or watched stock statistics, for example by selecting display buttons 214, 216, 218 respectively.

The view of stock market information interacts between the application running on the client machine and the service running on the web. As the user makes changes to the portfolio or the watched stock list, this new information is transmitted to the provider and the requested new information is displayed.

FIG. 9 also illustrates a tracking system 224 according to one embodiment of the present invention. The tracking system collects and transmits back to the provider selected information regarding the user's use of the stock check application. In this example, the name 226 of the stream transmitted to the user is displayed, as well as other information including the number of impressions 228 of this stream and the length of time 230 the stream has been open. The exemplary tracking system also displays statistics 232 reflecting the parts of the stock check object that the user selected by clicking and the number of times each part was selected.

FIG. 10 is a graphical user interface illustrating symmetric event driven communication for non-personal computer devices according to one embodiment of the present invention. FIG. 10 shows the same Level One application 212 as that illustrated in FIG. 9, but running on a personal digital assistant (“PDA”) 240. In this example, no Web browser is required, but the PDA provides the same screen display and information as did the personal computer of FIG. 9. This Figure illustrates the use of a device-appropriate user interface. There is direct integration between the client and the server application, with no need for a Web browser on the client. In addition, there is no application-poll communication load.

FIG. 11 is a graphical user interface illustrating integration between a Level One application according to the present invention and a networked prior art message service application. FIG. 11 shows instant, event driven updating. A return channel allows both tracking and confirmation. In addition, response capabilities build into base standards. In this example, when a message to the user, such as a voice mail, e-mail, or fax, arrives on the provider's server, the provider sends a notification 250 to the user using the communication system according to the present invention. The communication system permits the provider to interact with the user to notify the user of events that have occurred on the provider's server. The user must then separately access the message service to retrieve any messages.

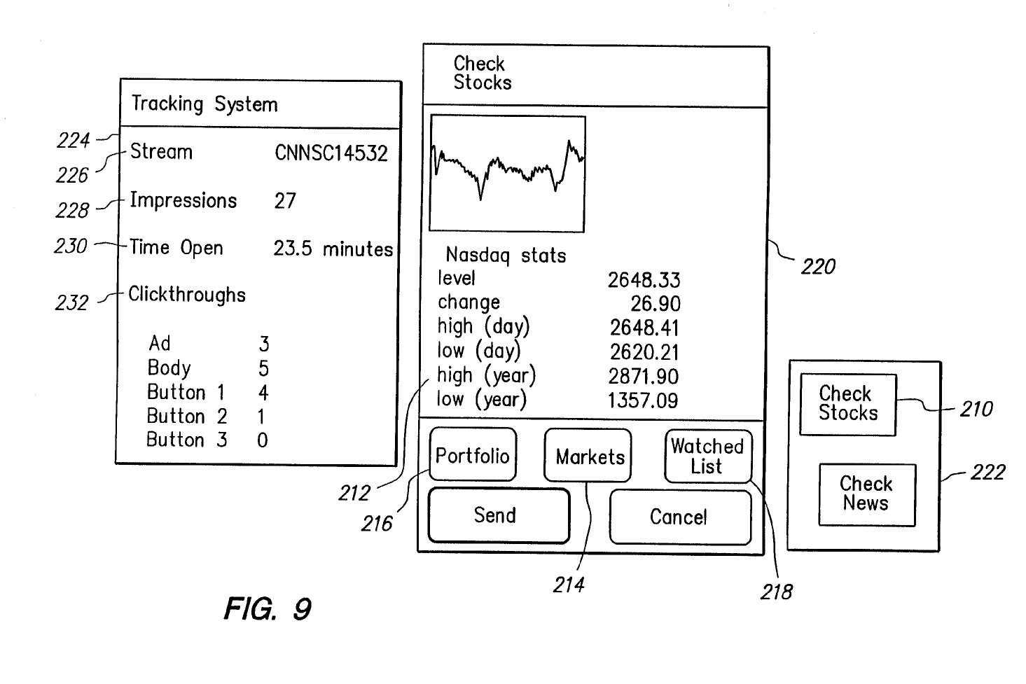

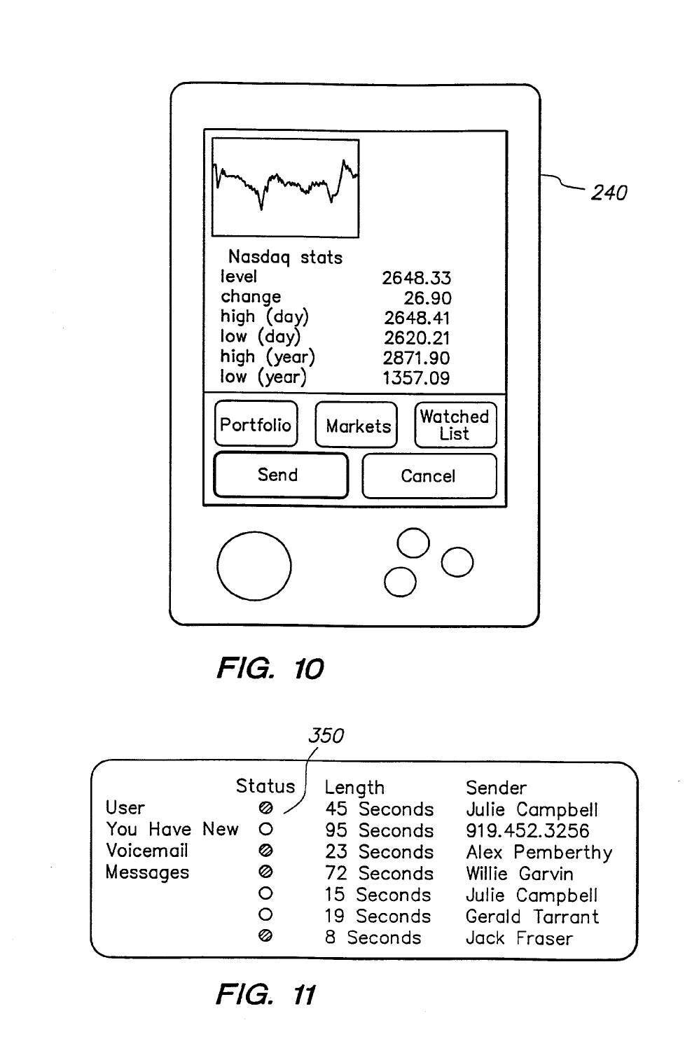

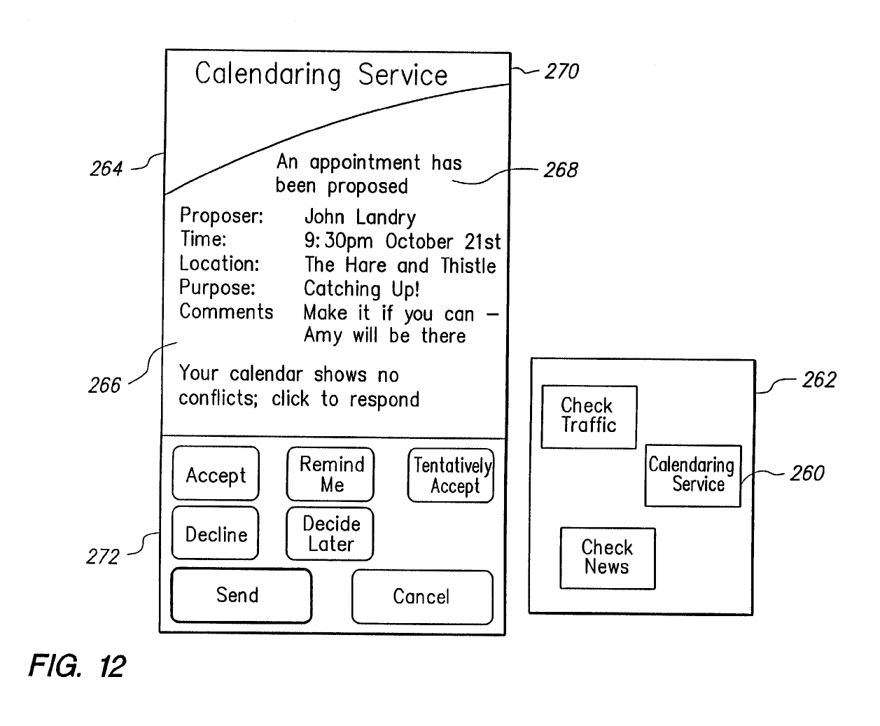

FIG. 12 is a graphical user interface illustrating integration of a Level One application according to the present invention with a networked calendaring service application. In this example, the user can select the icon 260 that represents the calendaring service that is shown in the application window 262 on the user's desktop. A window 264 is then displayed presenting the calendaring service application 266.

In this example, the user is notified of a proposed meeting by the delivery of a message 268 using the present invention; that message is used by the application to update the calendar with the new information. In one embodiment of the invention, the object displays the service provider's branding 270. In the example provided in FIG. 9, the user is permitted to interact with the service provider by selecting displayed responses 272 that are transmitted back to the service provider.

In the preferred embodiment of the present invention, a plurality of windows displaying different applications can be open and active on the user's desktop at the same time. However, in alternative embodiments, only one such window can be active at a time.

FIG. 13 is a graphical user interface illustrating a Level One NetButton according to the present invention. FIG. 13 shows an appliance user interface that is simple, focused, and intuitive. A click-through feature permits access to the application Web site to allow fulfillment of non-standard and complex requests. In this example, a NetButton 276 is used to represent an application 278 for a multimedia email delivery system. This application is designed to enable the user to record and send a voice mail to a designated phone number 280. If the user wishes to carry out some other task, access to the mail service Web site is provided through an icon 282 displayed within the NetButton. By selecting this button, the user's Web browser is activated, if necessary, and the user can access the Web site to perform activities not supported by the NetButton application.

In a Level Two application, the application provider writes software that is operable on the user's device. For example, a pager company can create a Level Two software application that displays a page on the user's desktop, as well as on the user's pager. In this example, the Level Two application functions as a desk accessory rather than as a complete software application.

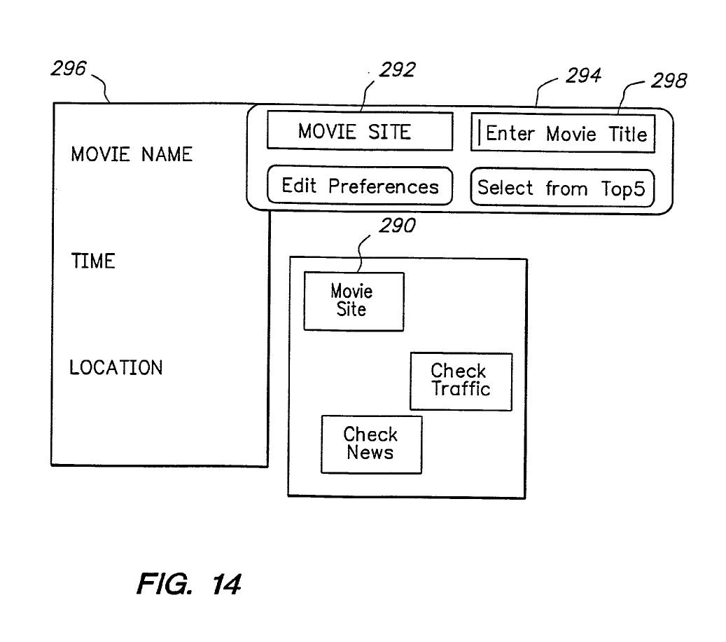

FIG. 14 is a graphical user interface illustrating integration between a Level Two application according to the present invention and a Web site. In this example, the invention allows the creation of focused sub-sets of application site functions. Fully bi-directional communication allows flexible, on-line and off-line operation. The communication system according to the present invention can be used to create focused subsets of Web site functions. For example, a NetButton can be created to provide the user with information and services that the user accesses frequently. In the example illustrated by FIG. 14, a NetButton 290 is created for a movie schedule Web site. When the appropriate NetButton 292 in the application display window 294 is selected, a Level Two application window 296 is opened. In this application window, the user can find out the time and location for a selected movie. In the preferred embodiment, the Level Two application can be configured, such as through preference editing, to modify the parameters of the application. Thus, the user can use the Level Two application to find movie schedules for any particular date(s) or location(s) as desired.

To receive additional information from the Web site, the user can access the Web site by selecting a control 298 provided in the application window. If the user has an active Web browser running, the browser will be directed to the selected Web site. If the browser is not active, selecting the button will open the Web browser application to the selected Web site.

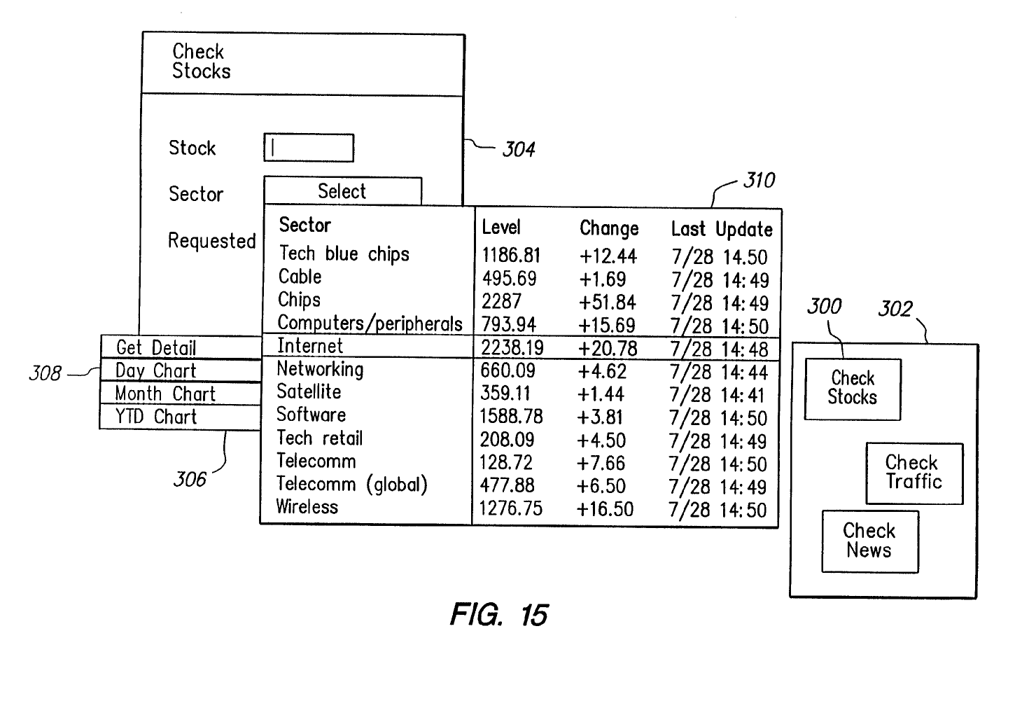

FIG. 15 is a graphical user interface illustrating a Level Two application for a client-driven transaction according to the present invention. In this example, selecting the NetButton 300 in the application display window 302 opens an application 304 that provides a greater level of user flexibility and control than the analogous Level One application illustrated previously with respect to FIG. 9. The Level Two application of FIG. 15 supports features such as complex drop-down menus 306 and permits the user to select a sector 308 and request various data charts 310 related thereto.

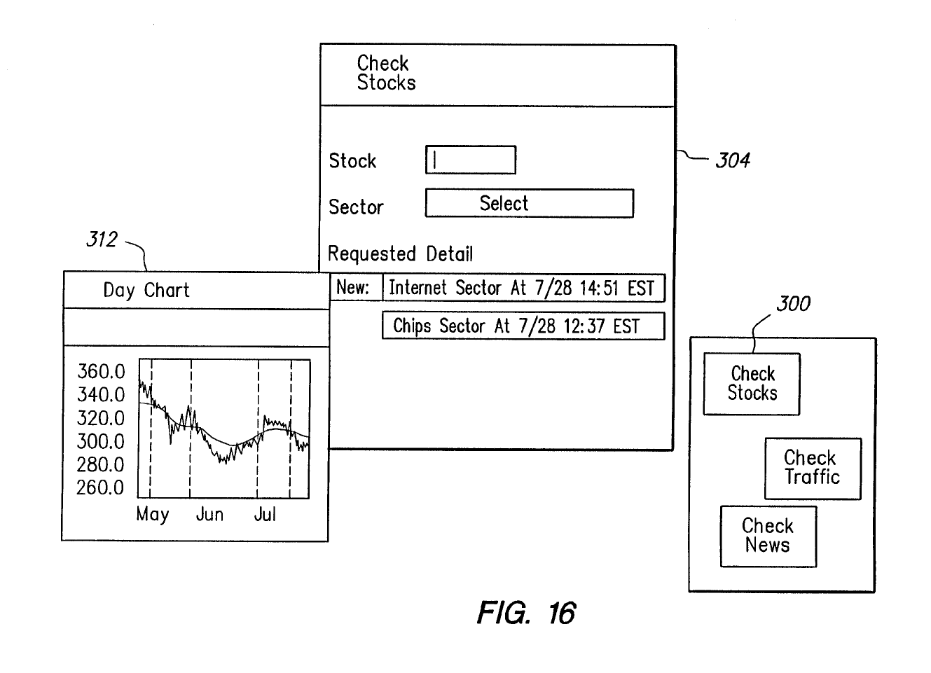

FIG. 16 is a graphical user interface illustrating a response to a client-driven transaction using a Level Two application according to the present invention. This Figure shows an example of a response 312 to a request for information as described in the example of FIG. 15.

A Level Three application is a desktop application that runs separately from the communication system software. The communication system software, however, provides the signal transfer mechanism for messages transmitted using the Level Three application.

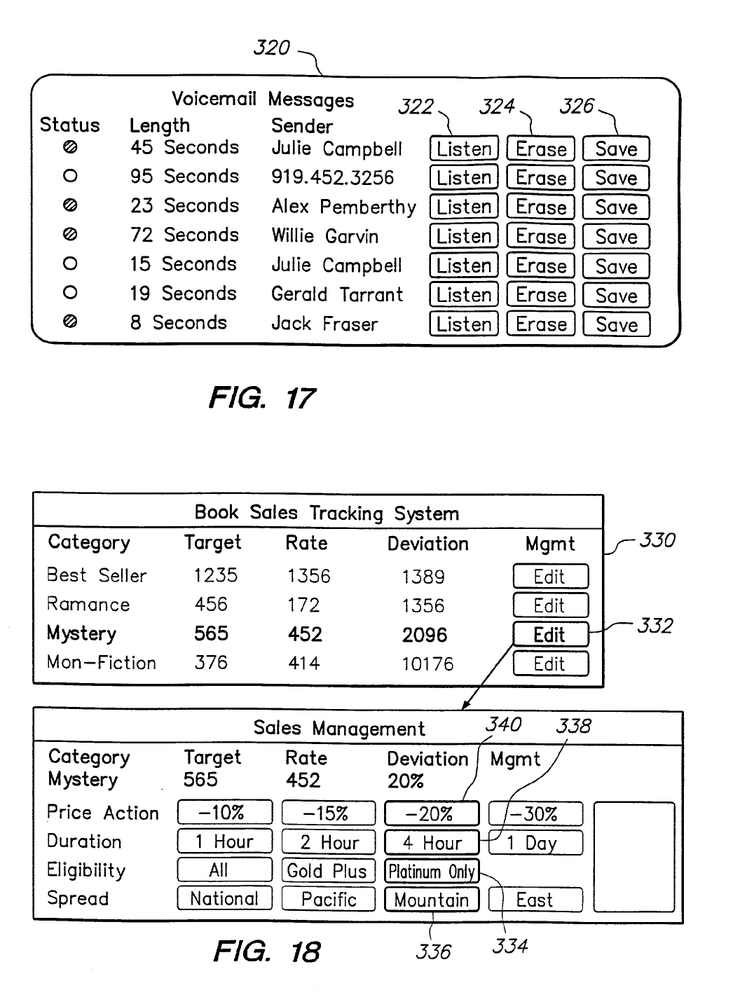

FIG. 17 is a graphical user interface 320 illustrating integration of a Level Three application according to the present invention with a networked prior art message service application. The Level Three application permits the user to listen to voice mail messages 322, to erase them 324, and to save them 326. This Level Three application provides more functionality and flexible application power than the Level One message server application previously described with respect to FIG. 11.

The following example is a comparison of electronic commerce merchandising according to the prior art and according to the present invention. In this example, a bookstore has determined that sales of mystery books have fallen below their desired minimum sales levels. As a part of a marketing plan, the bookstore has decided to offer special discounts to their customers for restricted periods of time.

FIG. 18 is an eCommerce sales merchandising system 330 according to the present invention. In FIG. 18, buttons indicating all platinum level customers residing in the Pacific region are to be offered a 20% discount on mystery book purchases during a four hour period 334, 336, 340, 332, 338 respectively. The impact of the discount can then be assessed.

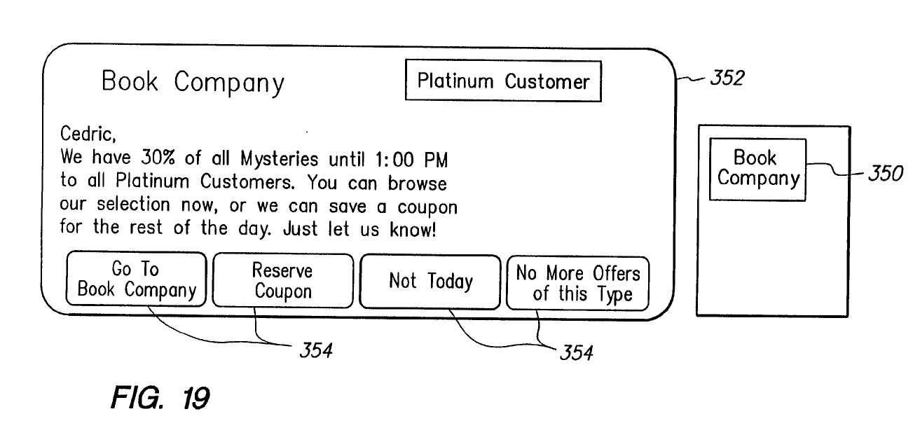

FIG. 19 is an eCommerce sales merchandising system that can be integrated with the present invention. The communication system according to the present invention enables a bookseller or any eCommerce vendor to transmit this promotional information to platinum customers by clicking a button. In this example, a platinum customer has a NetButton 350 for the bookseller displayed on the desktop of the customer's personal computer, or other networked or addressable device. When the promotional information is received by the customer, the customer's NetButton can be configured to provide a notice of the receipt of the message, for example by flashing. If a customer selects the NetButton during the promotional period, an application window 352 notifying the customer of the promotion is opened. In the example illustrated in FIGS. 18 and 19, a Level Two application is used to provide this notification. The customer can elect to respond to the promotional offer through the mechanisms 354 enabled by the Level Two Application, or can elect to open a Web browser to respond to the promotional offer through the bookseller's Web site. The present invention thereby provides a two-way interactive instant messaging system for communication between a customer and an eCommerce Web site, minimizing the likelihood of inappropriate or expired communications.

One feature provided in the preferred embodiment of the present invention is an interface to the underlying interactive connections of the communication system. This interface, referred to herein as a “TubeTop” is an iconic representation of a permanent connection, referred to herein as a “Tube”, to at least one other address on the electronic network. It is possible to use the TubeTop and Tube system to exchange messages between points on the electronic network e.g. to a user or to a particular device. The present invention provides two types of basic connectivity capabilities. A Tube is a one-to-one connection for bi-directionally publishing and receiving messages. A second type is a one-to-many architecture, referred to herein as a “pool”.

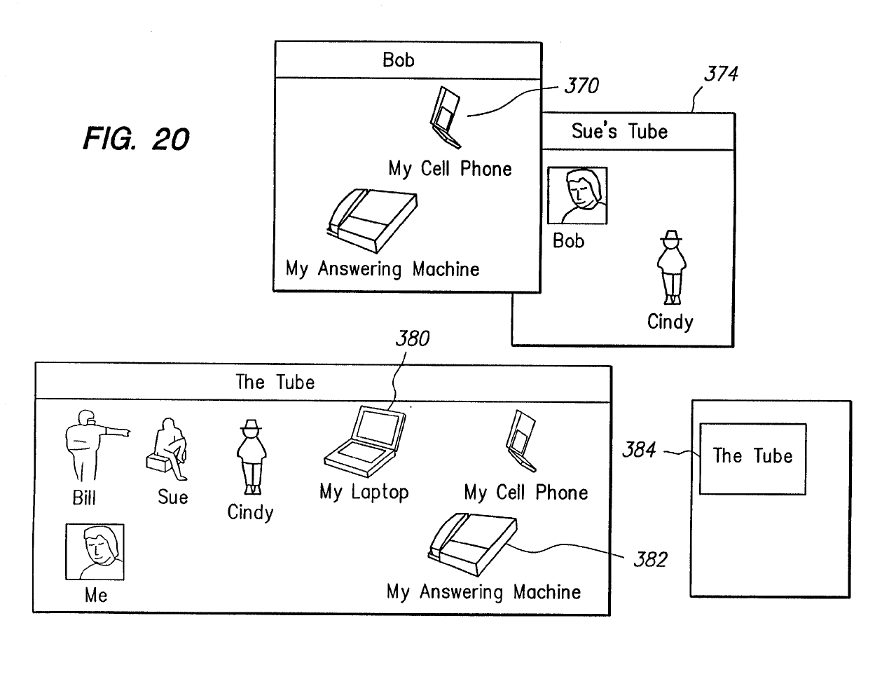

FIG. 20 is a graphic user interface display illustrating Tube connection according to the present invention. In this example, a first user, “Bob”, can enable one or more other users to be able to send a message to the first user's cell phone by dragging the cell phone NetButton 370 onto the NetButton(s) for the other user(s). Thus, if the first user drags the cell phone NetButton onto the NetButton 372 for Sue, then Sue will receive through her Tube 374 a NetButton (not shown) for the first user's cell phone. Sue can then use this cell phone NetButton to send information to, and receive information from, the first user's cell phone.

The TubeTops according to the present invention can be used to represent with icons or NetButtons any individual person, groups of people, or device on the electronic network, including but not limited to a laptop computer 380, cell phone, or answering machine 382. These icons or NetButtons represent the ability to send information to or receive information from the respective people, topics, or devices through the communication system.

It is possible to select a particular device to which a message will be sent, such as the cell phone of the previous example. Alternatively, the message can be dragged onto an icon representing a person. The message will then be delivered to any appropriate sub-address of that person according to the type of the message, as described previously. Thus, the communication system according to the present invention would deliver a telephone message to the selected user's telephone, while a fax message would be directed to the user's fax machine.

The TubeTop 384 is essentially a defined standard interface sitting “on top” of a Tube and that leverages all of the Tube's abilities to send and receive objects interactively to enable appliance-like applications to interact and deliver any kind of focused functionality The TubeTop feature according to the present invention can readily be used to facilitate topic-based communication. For example, a group of individuals who subscribe to a chess game topic would each have a chess game TubeTop on their desktop. When one participant moves a chess piece, each subscriber to the topic will receive this information and will view the move upon establishing communication with the electronic network.

The TubeTop feature can be used as an interface to particular functions or services. For example, a TubeTop can be provided to a language translation service. A document dragged onto this TubeTop icon is transmitted to the translation service. The translation service can then return the document by responding to the original message, or by any other known means. This feature is especially advantageous for eCommerce because it permits a vendor, such as the language translation service, to readily charge a fee for each service performed, and to automatically track such transactions.

In another example of Tube delivery, a TubeTop can be provided for a shipping service. A document dragged onto the TubeTop can be printed by the shipping service, assigned a tracking number, and then delivered to the intended party.

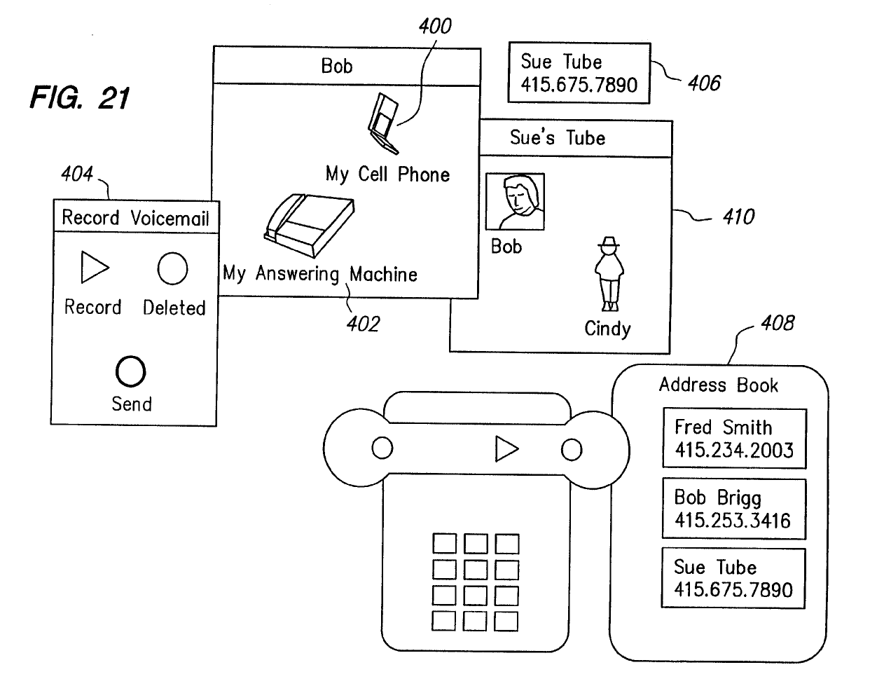

FIG. 21 is a graphic user interface display illustrating Tube connection with intuitive, device-and-application-level addressing according to the present invention. When a TubeTop 400 NetButton is selected, an application window appropriate to the respective NetButton opens. For example, selecting a NetButton 402 for an answering machine will open an application window 404 that permits the recording of a message to be delivered to the answering machine.

The Tube delivery feature can be used to transfer information directly to a file or to an application. For example, a first user can transfer a contact address 406 directly to a second user's address book application by dragging the contact address onto the second user's TubeTop 410. The message type is then recognized and the message is delivered to the second user's address book application 408. Alternatively, a TubeTop can be provided for the second user's address book itself.

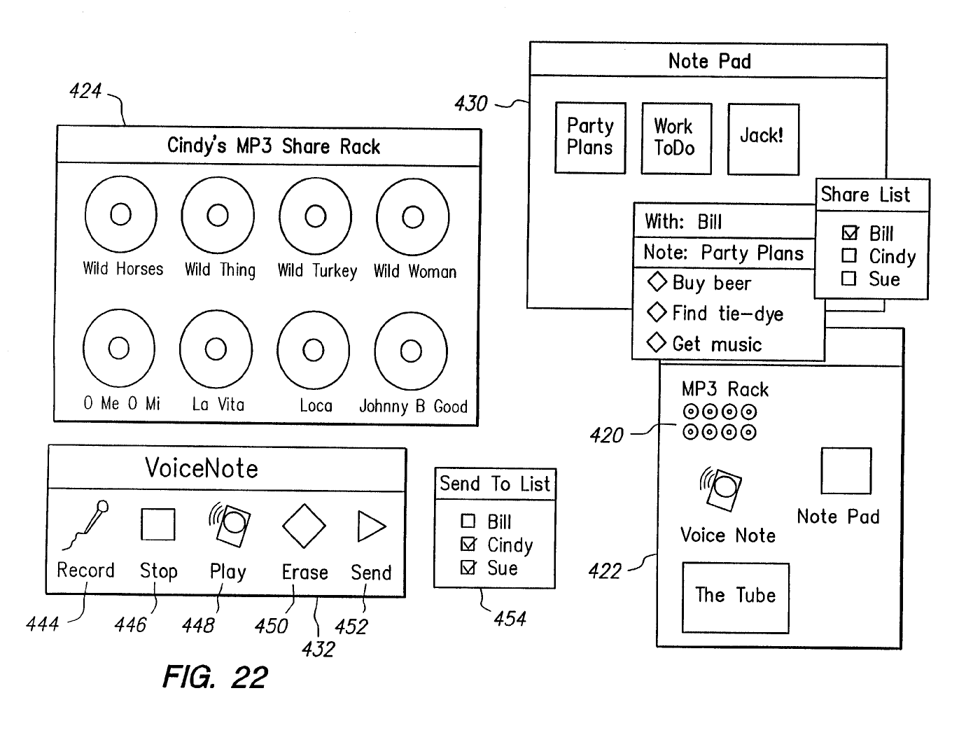

FIG. 22 is a graphic user interface display illustrating personalized Tube connection according to the present invention. FIG. 22 shows examples of three different types of TubeTops. One type is an MP3 rack TubeTop 420. When the MP3 rack TubeTop is selected from the application display window 422, an application window 424 with a shared rack representing a set of MP3 audio files is opened. An MP3 file that is dragged onto the MP3 shared rack is delivered to every other device that has that MP3 application rack. This type of TubeTop permits users to build and share mutual collections of MP3 files. One skilled in the art will readily recognize that this type of TubeTop is not limited to audio files. Rather, this type of TubeTop can be used to build mutual collections of any type of message that can be transmitted over the electronic network, including but not limited to graphic files, text files, addresses, and Web site uniform resource locators (“URLs”).

In another type of TubeTop 430, the Tube delivery feature can be used to share information. Thus, party planning notes can be shared with some or all of a group of people. Any person who is sharing the notes can write additions to the notes. These additions are instantly shared with all other persons who are sharing the party planning notes. The third type of TubeTop 432 shown in FIG. 22 is a voice note application. This application enables a user to record 444, stop recording 446, play 448, erase 450, and send a voice note 452 to a selected person(s) 454.

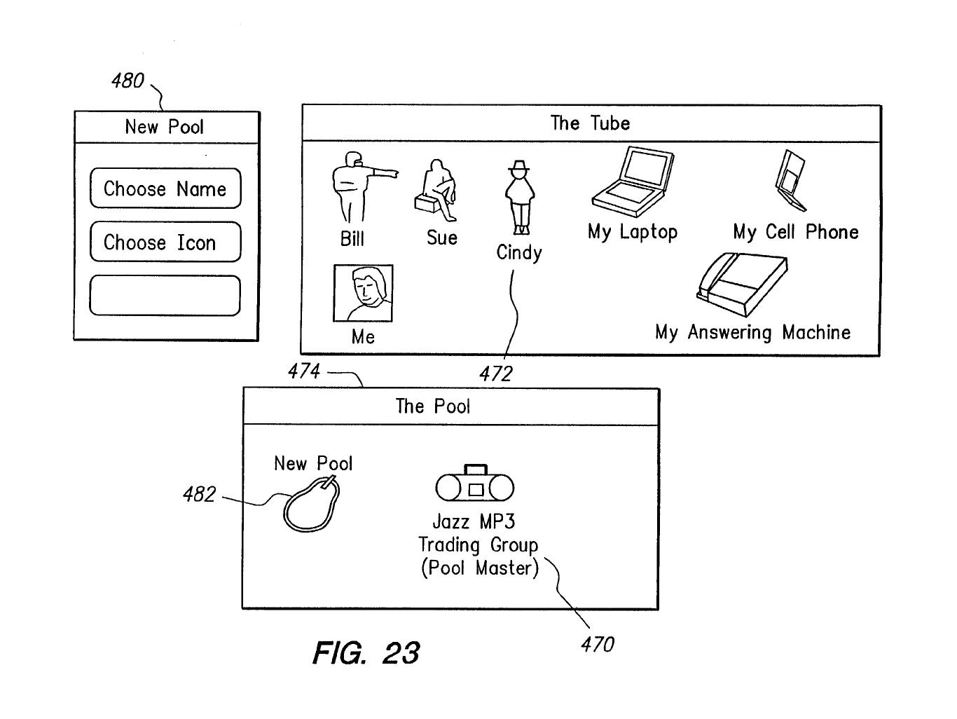

FIG. 23 is a graphic user interface displaying one-to-many communications using a Tube connection according to the present invention. FIG. 23 illustrates an example of a topic or a stream to which a plurality of people (referred to as a “pool” 474) have subscribed, the jazz MP3 trading group. The icon for the jazz MP3 trading group 470 can be dragged onto a Tube 472 for a user of the communication system to invite that user to join the trading group. If this invitation is accepted, then all information that is shared with subscribers of the trading group is delivered also to the new subscriber through Tube delivery. In alternative embodiments, subscriptions to a group can be initiated using Tube delivery while information is delivered by any known means, such as by e-mail.

In addition, a message, such as an MP3 that is dragged onto the trading group icon is sent to each subscriber of the group. FIG. 23 therefore illustrates delivery of one to many, or “pool” communication. An application 480 for creating a new pool and activated using a NetButton 482, can also be provided.

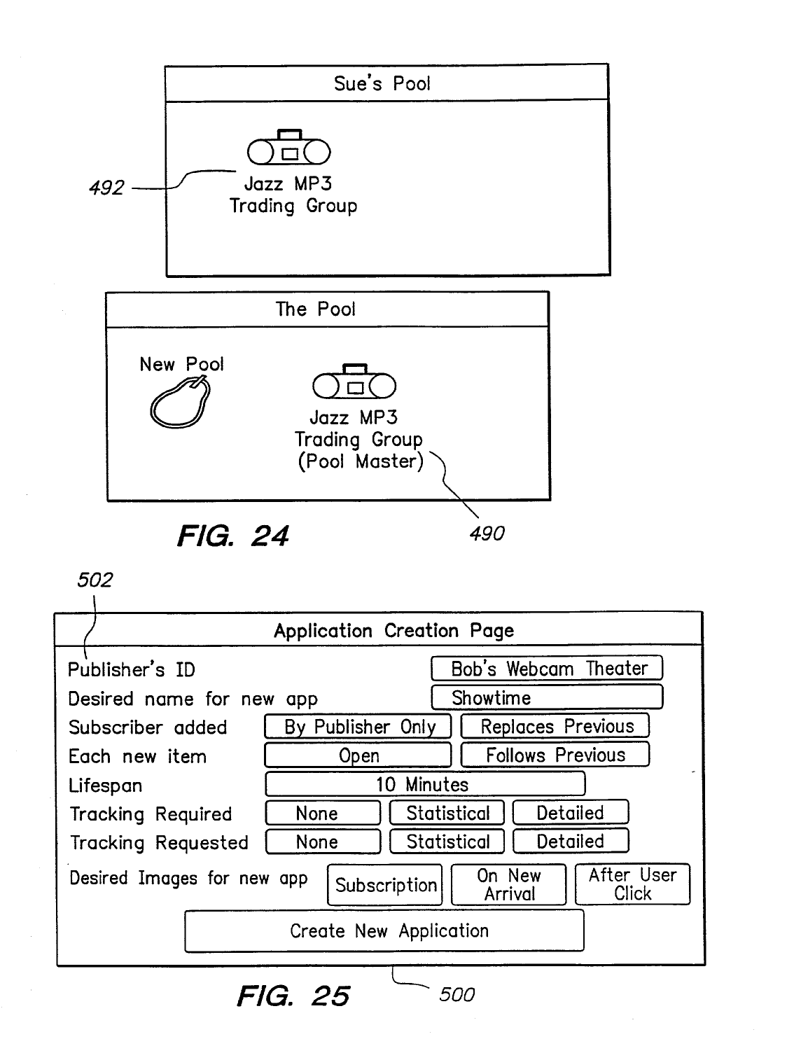

FIG. 24 is a graphic user interface display showing moderated personalized Tube connection according to the present invention. In this example, a moderator, referred to in this example as a “pool master” 490 controls any restrictions on publishers to and subscribers of the group 492. The moderator can be a person or can be a software application, such as a filter. For example, the moderator can retain the exclusive right to invite new subscribers “into the pool,” i.e. to join the group. The moderator can also control the messages that flow into and out of the group by designating who is authorized to publish messages and who is authorized to receive certain messages. It is therefore possible to provide moderated exchanges in which, for example, confidential information is distributed only to authorized parties.

The communication system according to the present invention can be used to enable users or small eBusinesses to create a micro publishing application. FIG. 25 is an illustration of application creation according to the present invention. In this example, Bob is the host of a “webcam” show in the Internet and wishes to notify subscribers that his show I will begin in 15 minutes.

One prior art method for providing this notification is by sending e-mail messages to each subscriber, However, this method is only effective if the subscribers actually receive and view the e-mail messages prior to the commencement of the show. Furthermore, the email messages that are not timely viewed can remain in a subscriber's message box as unnecessary clutter.

However, the communication system according to the present invention supports Internet or client-based application creation. Bob can log to the Web and use the communication application creation page 500 to describe parameters 502 for the notification. For example, Bob can indicate whether or not he wants to retain exclusive control over the subscription list, the lifetime of a message, the levels of desired required or requested, if any. Thus, the notification can be configured to be deleted or replaced once the show to which it refers has ended.

In addition, the communication system enables setting up the icons and other characteristics that are associated with the new application. For example, one icon can be associated with a subscription. Characteristics such as notification alarms, or sounds can therefore be selected.

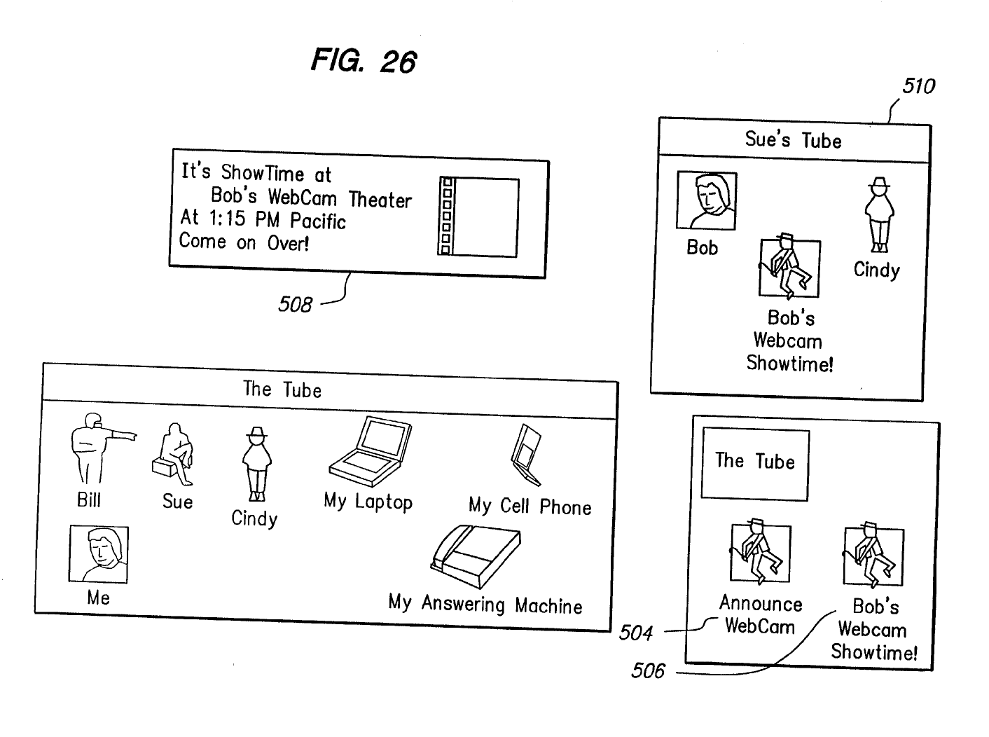

FIG. 26 is a graphic user interface display showing communication of an application created according to the present invention. The example of FIG. 26 assumes that a new application has been created as described with respect to FIG. 25. In this example, two icons are created—a subscriber object 504 and a publisher object 506. The subscriber icon is used to invite persons to be subscribers to the stream, in this case, the webcam show. The publisher object allows a person to send information to that stream. Any information in any form that is dragged onto the publisher object is distributed to all of the subscribers 510 to the stream. In the context of a webcam show, for example, any messages 508 that are dragged onto the publisher object are sent out to the subscribed audience, to advise them that the show is about to begin.

While the invention is described in conjunction with the preferred embodiments, this description is not intended in any way as a limitation to the scope of the invention. Modifications, changes, and variations which are apparent to those skilled in the art can be made in the arrangement, operation and details of construction of the invention disclosed herein without departing from the spirit and scope of the invention.

In the preferred embodiment of the present invention, a digital signature is required for entry of a message into the system. This feature can be used to minimize, if not to entirely eliminate, spam messages. A well-known system, such as that implemented by Verisign can be used to authenticate the digital signatures. Encryption, such as a public/private key system can also be used to further insure the security of message transmission according to the present invention.

The communication system server according to the preferred embodiment of the present invention can additionally provide transform capabilities at the communication system server. Thus, as objects are transmitted through the system, the communication system server can be used to perform arbitrarily complex transformations on these objects to provide value either to the message publisher or to the recipient. These transform capabilities can be implemented using software applications created either by the communication system server operator or by any other users in communication therewith over the electronic network. Alternatively, these transform capabilities can be implemented using applications installed in or accessible to user devices, such as an application stored on the user's desktop computer.

For example, the communication system server can be configured to provide a format translation for a message. Thus, a publisher can send a message in a first format with an instruction that the message is to be delivered in a second format. The communication system server will then translate the message format and transmit the resulting message to the intended recipient. Other transform capabilities that can be provided in the present invention include but are not limited to localizing or translating a message's language.

In one embodiment of the invention, interactive applications on a client device can be configured to permit interactive communication among the applications. For purposes of explanation only, this embodiment of the invention will be described with respect to NetButtons. However, one skilled in the art will recognize that these teachings can also be applied to any type of active applications having client-side logic that permits interapplication communication or interactive communication across an electronic network, including but not limited to streaming audio and video applications. In addition, while only one page of a prior art Web browser can be active at a time, it is possible to use the present invention to provide interapplication communication between an active Web site, as viewed using a Web browser, and another active application such as a NetButton or streaming audio application. While the teachings of the invention can be applied to interapplication communication between different Web sites, there will be a time delay in communication as the inactive application is made active.

This embodiment of the invention differs from the prior art dynamic data exchange method of communication because it uses a common semantic and syntactic specification that is mutually understood between the communicating elements and is defined for personal, eCommerce or eBusiness use. In the preferred embodiment, those semantics are defined within a well-known standard syntax such as XML. This set of semantics is used to broker communication and transactions among the applications on the client. In alternative embodiments, the communication can be enabled using other language specifications. When this communication among applications occurs on the same client device, the communication can occur both when the user is on-line or off-line. When the user is on-line, the applications can query their respective home web sites, or eCommerce applications, or applications on other client or server devices to update any offers or information.

In the invention, an interactive application such as a NetButton is able to publish certain information by making this information available, preferably selectively, to other applications located on the same client device. In the example of an on-line pharmacy application, the application can publish information included but not limited to the name of the vendor, the applications that are permitted to receive the published information, a product being offered for sale, and an offer code number to access the for-sale product. In the preferred embodiment, this information is published in semantics which are compliant with the syntax of the XML language.

Another type of information that can be published by a NetButton is an identification of which other NetButtons are permitted to receive this published information. Thus, for example, a company can publish information only to NetButtons of related or allied companies. This provides a level of security for the published information.

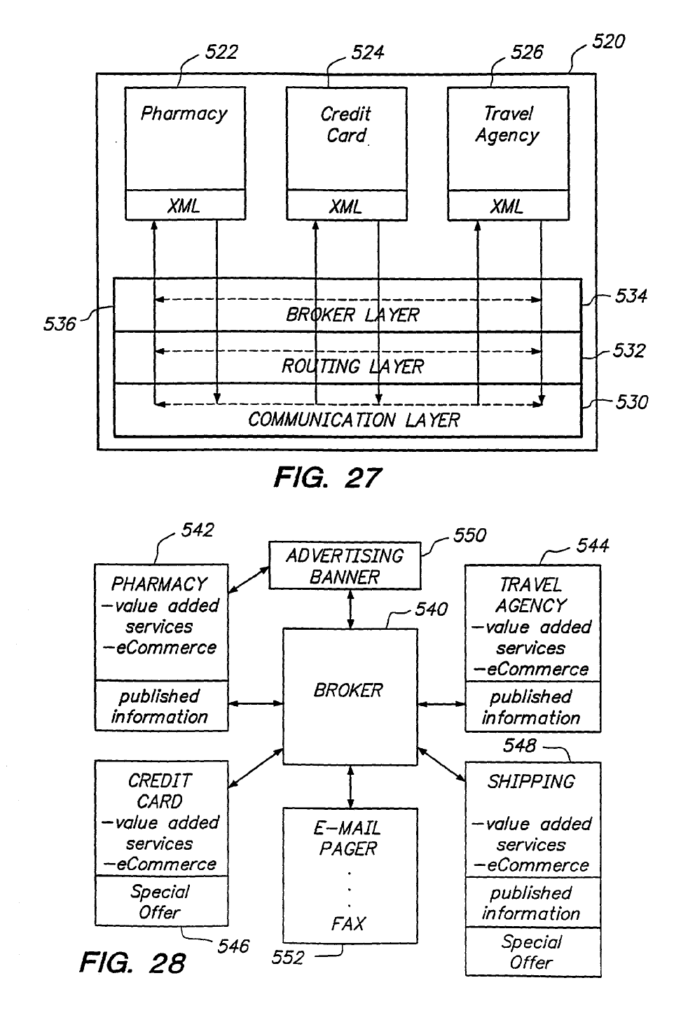

FIG. 27 is a system diagram illustrating communication among applications on a processing device according to the present invention. In the example illustrated by FIG. 27, the client device 520 includes NetButtons for an on-line pharmacy 522, a credit card company 524, and for an on-line travel agency 526. These NetButtons can include any combination of Levels Zero through Three applications. In a first embodiment, information published by the pharmacy is directed to a communication layer 530 of the underlying software platform 536 of the present invention. This communication layer passively broadcasts the published information to all NetButtons on the client device.

In a second embodiment, the underlying software platform includes a routing layer 532 that is operable to direct published information from one NetButton to another specific NetButton or group of NetButtons. In this second embodiment, explicit addressing can be implemented in the message routing layer such that published information can be routed to specific NetButtons. The routing layer can be configured to determine the origin of published information and, in response thereto, to direct the published information to preselected NetButtons or types of NetButtons. Thus, for example, published information regarding a sale by an on-line pharmacy can be directed to NetButton applications for a credit card company and for a shipping company, but not to a NetButton for an on-line music distribution service.

In the preferred embodiment of the present invention, a broker 534 is used to intelligently mediate the transfer of published information. Thus, the broker adds a layer of intelligence to the explicit addressing permitted by the routing layer. This embodiment is advantageous because the broker can be used to provide a layer of security to the transfer of published information. The broker can be implemented as a standalone application or can be implemented as a part of the underlying software layer. This underlying software layer can be a part of the dedicated software platform that has previously been described with respect to the invention. Alternatively, the underlying software layer can be a separate software application from the dedicated software platform.

In the preferred embodiment, the only communications among NetButton applications on the client device are those that are explicitly enabled by the user. The user can configure the broker application to regulate the sources of published information, as well as the allowed destinations to which this information can be transmitted. Thus, the user can restrict the on-line pharmacy from publishing any information regarding the user's ordering history to the credit card application, but can permit this information to be transmitted to the shipping company. Similarly, the user can configure the broker to deny all publication of information, or to permit information to be published and transmitted to and from any and all NetButtons without restriction.

Another advantage of using a broker is the ability to mediate special commercial arrangements or deals among vendors. The broker can be provided with the information that there is a relationship between the on-line pharmacy company and the credit card company. Thus, the broker can make the user aware of special deals. For example, when the on-line pharmacy publishes sale information to the broker, the broker can notify the user that a related deal is being offered by another company and can provide the user with information regarding how to access this related deal, such as by downloading a NetButton for the other company to the client device.

Yet another advantage of using a broker is the ability to provide the broker with special instructions, requirements, or preselected criteria. As an example, the user can configure the broker to accept any sale of particular merchandise from the on-line pharmacy at a predetermined price. The user can instruct the broker to transmit information regarding this sale directly to the credit card NetButton with an instruction to purchase the item.

A broker can be provided as any level application, from Level Zero through Level 3. In the preferred embodiment of the present invention, the broker has a set of modifiable characteristics. In one embodiment of the invention, the broker is configured to accommodate different user experience levels. Thus, a beginning user can use a more simple, predefined interface to mediate transfer of published information, while a more experienced user can customize the interface to meet the user's requirements.

FIG. 28 is a system diagram illustrating an example of broker-mediated communication among applications according to the preferred embodiment of the present invention. In the figure, a broker 540 is used to mediate the transfer of published information among an on-line pharmacy application 542, a travel agency application 544, a credit card application 546, and a shipping company application 548. In this example, the NetButtons for the on-line pharmacy, credit card, travel agency, and shipping company offer the user value added services as well as eCommerce functionality. Thus, the on-line pharmacy NetButton can display value added services, such as a user-accessible formulary, and eCommerce functions such as the on-line sale of pharmaceutical items.

A NetButton that receives information published by another NetButton can respond thereto by publishing its own information. As an example, the pharmacy NetButton can publish information regarding a sale. When this notification is transmitted by the broker to the credit card NetButton, the credit card company can respond by publishing an offer to give the user a discount if the user buys the sale merchandise from the on-line pharmacy using the company's credit card. In another example, a travel agency can use the present invention to publish information regarding a tropical vacation. The on-line pharmacy can respond by publishing a sale price for suntan lotion, and the credit card company can publish a discounted rate for payment by credit card. That publication can occur by putting up a display message or graphic on the computer screen, or by communicating directly with the on-line pharmacy application. The user can then use any other appropriate means to respond to this offer. For example, the user can drag the NetButton for the credit card onto that for the on-line pharmacy, in accordance with the teachings of the present invention, to pay for the merchandise.

In one embodiment, advertising banners 550 displayed in the client desktop can be linked to any or all NetButtons and to the broker. Thus, when a NetButton publishes information regarding a sale to the broker for transmission to another NetButton, the broker can initiate the display of an advertising banner in response to this published information. In the example of the tropical vacation information published by the travel agency, an advertisement for a car rental company can be displayed in the banner in response thereto. Alternatively, the NetButton can publish information directly to an advertising banner as well as to the broker.

In one embodiment of the invention, the user can configure the broker to respond to preselected criteria. For example, the user can instruct the broker to purchase an item from the on-line pharmacy if a particular sale price is published by publishing information from the user's credit card NetButton to the NetButton of the on-line pharmacy. The user can instruct the broker to transmit a message 552 such as a query or to forward the message to the user at some convenient location, for example by e-mail, pager, or fax upon the occurrence of a specific event. The user can then communicate a response to the broker. Thus, a user can be immediately notified when the on-line travel agency publishes information regarding special rates for a vacation and can instruct the broker to purchase the vacation or to request further information from the travel agency.

In another embodiment of the present invention, the broker can be used to communicate among non-business related applications on the client device. For example, the broker can be used to mediate transfers of published information such as notices of upcoming events. In addition, the teachings of the present invention can be used in conjunction with the TubeTop interface to exchange published information among applications on the client device or among any points on the electronic network. For example, the broker can be configured to publish information about a vacation to a NetButton on the client device for a credit card as well as to a TubeTop for an organization that frequently sponsors trips for its members.

Interapplication communication according to the present invention can use the TubeTop and tube system to exchange messages between points on the electronic network e.g. to a user, to an application, or to a particular device. This preferred embodiment can also use to advantage the addressing capabilities of the invention. Therefore, published information can be distributed to addresses and sub-addresses based upon an arbitrary user-defined set of rules, as has been described previously with respect to message routing.

For example, a NetButton for an on-line music distributor can publish information about a sale of a performer's CD. This information can be published not only to other NetButtons on the client device, but also to a TubeTop on the client device for a fan club of that particular performer. Thus, the published information will also be distributed to other client devices.

### Other Embodiments

The World Wide Web (“Web”) has evolved from first generation Web systems that simply provided information to client computers over the Internet through a Web browser program to second generation systems using application servers that provide dynamic, personalized information and powerfill back-end transaction processing.

Despite advances in client-server technologies, present Web-transaction systems do not provide a robust and efficient communication platform to support high performance and secure commercial transactions involving multiple parties. Present Web applications are still unreliable and can fail on even the slightest communications problem. Web-based applications are also slow compared to resident or dedicated client/server communications systems. Although server and client computer processing speeds are high, present Web browser communication models are typically unreliable, limited and inefficient. The fact that present Web-based applications are based upon a document transmission model represents a fundamental limitation that prevents robust and efficient extension into application or transaction based processing.

Electronic Commerce (“e-commerce”) has become a fundamental application for Web-based transaction models. The convenience of buying and selling products and services over the Internet has allowed producers and retailers to effectively globalize their potential markets. On-line business models have become successfully adapted to distribute all manner of products and services over the global network. With the use of networks to pay for such goods, commercial transactions are increasingly conducted entirely over the network. This new commerce model affects both traditional buyer-seller transactions and commercial business-to-business transactions. Automated billing procedures allow the transfer of money between computer applications. For this application, business rules are typically implemented on the sending and receiving computers, and filters are often used to correctly route the payment transaction.

Along with the wide distribution networks and the increased spread of potential customers, on-line retailers are faced with increased problems of product supply, customer billing, and account management. Present Web-based systems do not provide satisfactory support for account management and product delivery models. User dissatisfaction arises from the lack of speed and reliability, and the complexities of order management over a browser interface. Because the client's Web browser must download each part of an application each time it is invoked, accessing the e-commerce site and switching between screens is slow and synchronous in that the user must wait for each transaction to be processed before conducting another. Moreover, any network failure during a transaction can cause it to fail with unpredictable results. Furthermore, the lack of an interactive connection between the buyer and seller forces the seller to use e-mail for any outbound communication, adding an extra layer of communication and forcing the user outside of the Web-based system.

The variety of on-line products, services, and content data continues to increase, as does the number of sources for those products and data objects. Customers may desire to purchase a composite product that is made up from several different types of data objects. For example, a downloadable music video can comprise several different types of data, such as video data, music data, and text data. Today, customers cannot purchase such a composite product because of the Web's inability to securely and reliably aggregate and transmit the data to the customer—each data object provider (content provider) must typically provide their data component individually to the customer.

Another significant disadvantage is payment of network distributed products. If the product is to be paid for, each provider is also independently responsible for collecting payment for their portion of the product. In addition, from the customer perspective, each customer may have to deal with multiple publishers of data objects separately, which further adds to transaction complexity. Present e-commerce systems generally do not allow for the efficient aggregation, common delivery and common billing of products or data objects provided by multiple content or data providers to a customer or a group of customers. At present, there exists no common way for content providers to establish the rules by which they will make their content available to one or more customers. There is also no common way for customers to decide under which circumstances they will receive and be billed for the products that are comprised of data objects. These problems are further compounded when the product represents data that may be used by a client application, rather than directly perceived or used by an individual.

A further disadvantage of present e-commerce product delivery systems is that they do not allow for specialized delivery to specific client devices. Various different types of devices are presently available for accessing Web-based content, such as computers, cell phones, PDA's, and the like. Each has different download and playback capabilities that present delivery systems do not differentiate among. This prevents appropriate price discrimination on the basis of the content delivered to specific client devices. Present e-commerce product delivery systems also do not allow for specialized delivery to other computer applications, that may use or further process the received product.

A network-based data object delivery and billing system for electronic commerce is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented on one or more computers executing software instructions. According to one embodiment of the present invention, server and client computer systems transmit and receive data over a computer network or standard telephone line. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers.

Aspects of the present invention can be used in a distributed electronic commerce application that includes a client/server network system that links one or more server computers to one or more client computers, as well as server computers to other server computers and client computers to other client computers. Typically users of the client computers access the server computers or other client computers to select and purchase products or services that are offered for sale by users of these computers. The product, billing, and shipping systems are typically maintained in databases stored in one or more server computers, or on client computers. Different entities may be responsible for different aspects of the transaction from the seller's side. For example, one company may be involved in the selling and shipping of product, while another is involved in the billing and collection of the finds from the buyer, such as a billing network operator.

In one embodiment, the distributed electronic commerce application includes a networked billing system that includes a switching network that couples a plurality of computers to one another. The switching network facilitates the delivery (transmission) and tracking of data objects and allows for the billing of these objects. For purposes of the following description, data objects represent digital data that are transmitted from one computer to another computer through the switching network, and may represent any type of digital content that is purchased, rented, leased, or otherwise downloaded and/or used in exchange for consideration. Such data may be referred to as “content”, “data product”, or other similar terms.

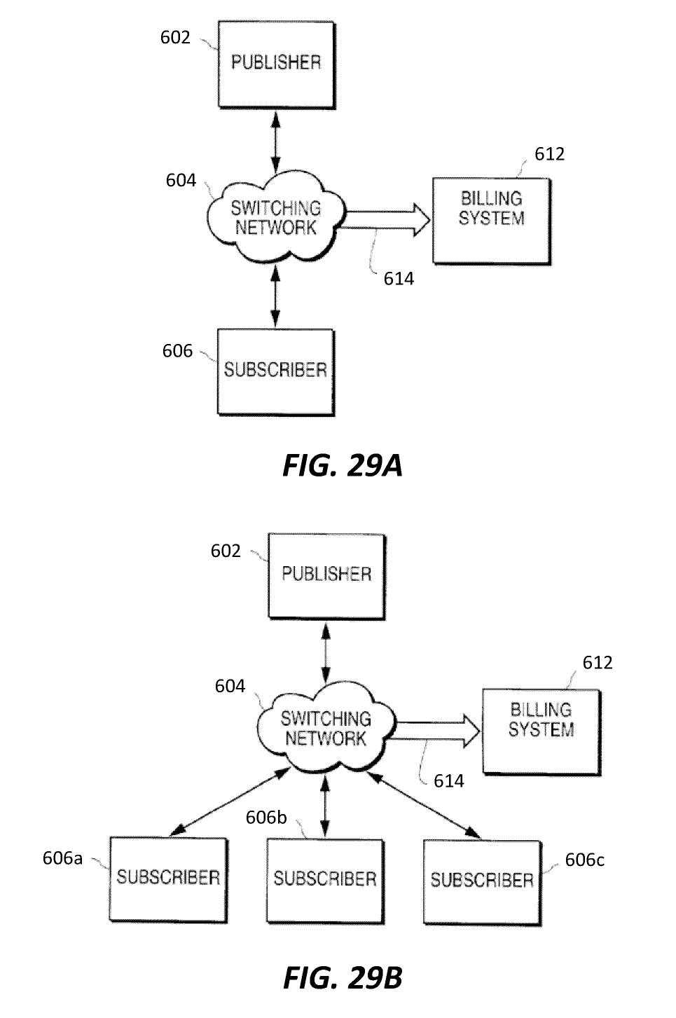

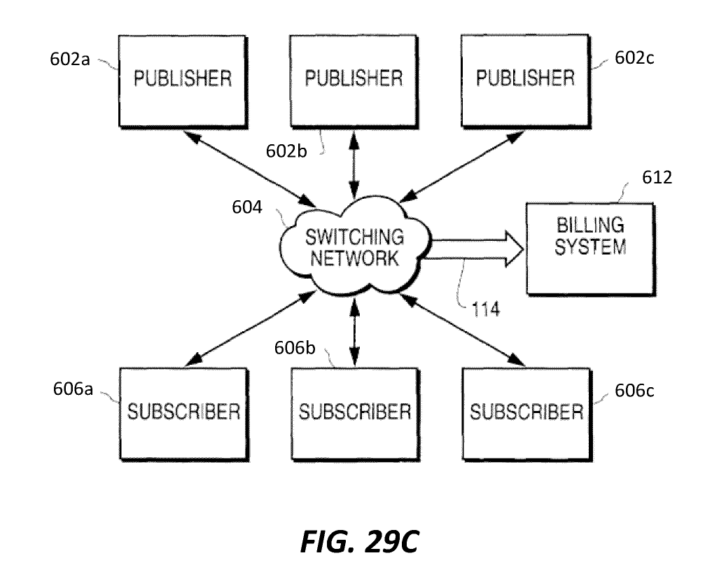

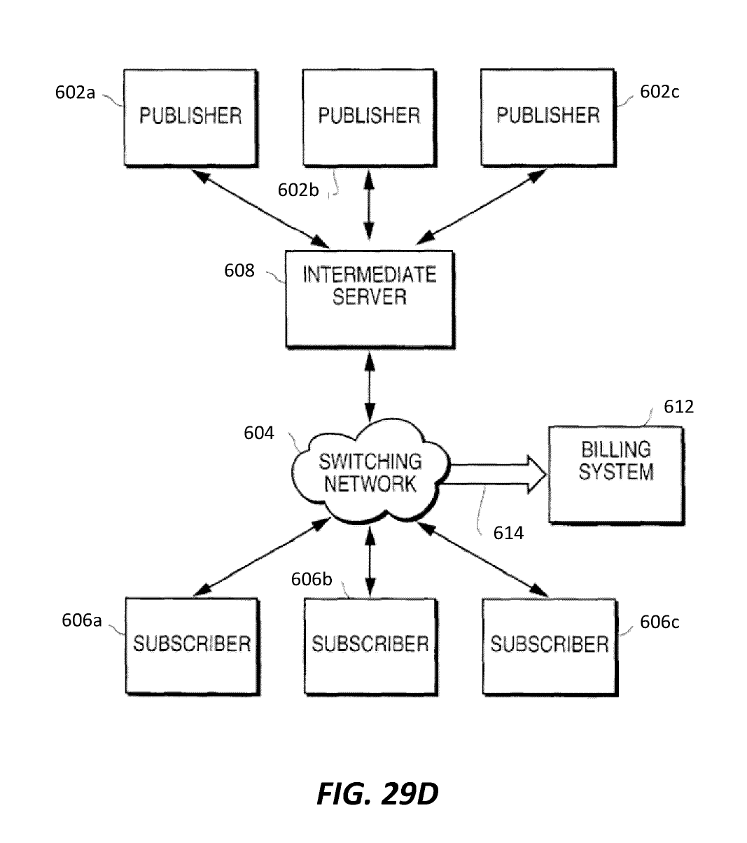

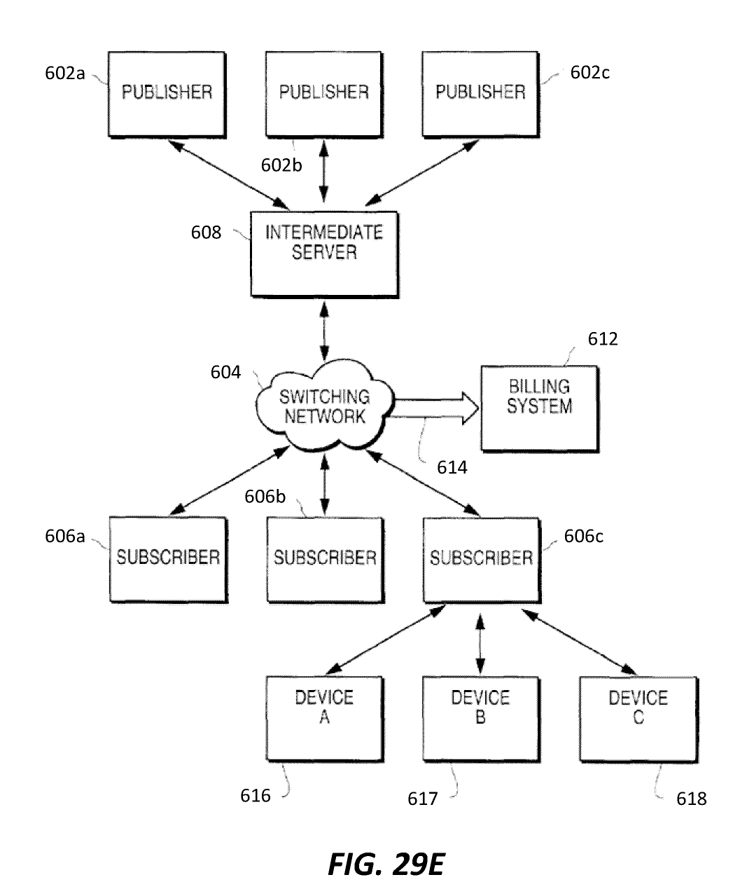

Several different network topologies may be implemented through the use of a distribution and billing system that utilizes a switching network according to embodiments of the present invention. FIG. 29A illustrates a network in which a content provider computer, referred to as a “publisher” 602 is coupled to a subscriber computer 606 through switching network 604. Typically, publisher 602 is a server computer that contains or is coupled to a content database, and subscriber 606 is a client computer that requests content to be downloaded from the publisher. Alternatively, content can be downloaded to the client computer when certain pre-defined events are met. The publisher may also be referred to as a “content provider”. The subscriber 606 may be a network computer or computing device that is operated by a user or individual; it may also be an application that uses the downloaded data and is executed by a network computer or computing device. Alternatively, either or both the publisher 602 and subscriber 606 computers may be client or server computers. As content data is downloaded from the publisher 602 to the subscriber 606, this data exchange is tracked and payment is transferred from the subscriber 606 to the publisher 602. The switching network 604 may also provide a gateway 614 to a billing system 612 that facilitates the ultimate billing and transfer of payment for the downloaded data.

FIG. 29B illustrates an embodiment of the network illustrated in FIG. 29A in which a single publisher 602 is coupled to more than one subscriber, denoted 606a, 606b, and 606c. Any or all of the subscribers may request the downloading of content data from publisher 602 over switching network 604 either directly or when pre-defined events occur. Similarly, more than one publisher may be available to provide content data to one or more subscribers. FIG. 29C illustrates an embodiment of the network illustrated in FIG. 29A in which a plurality of publishers, denoted 602a, 602b, and 602c are coupled to a plurality of subscribers 606a, 606b, and 606c through switching network 604. The publishers 602a-c may provide separate and distinct content data objects, or they may provide portions of a comprehensive data object to be downloaded to the one or more subscribers.

An intermediate server 608 may be provided for the embodiment in which content data is provided by several publishers 602a-c. This embodiment is illustrated in FIG. 29D. For this embodiment, the intermediate server 608 may receive different content data objects from the publishers 602a-c and package these objects for download to the subscribers according to specific packaging rules.

In one embodiment of the present invention, the content data downloaded to a particular subscriber may be directed to a particular type of subscriber network computing device. A subscriber may be coupled to the switching network 604 through any number of different network computing devices, such as a personal computer, personal digital assistant (PDA), cellular phone, or similar type of network device. FIG. 29E illustrates an embodiment of the network illustrated in FIG. 29D in which a subscriber 606c is coupled to, or implemented by, one or more different types of network computing devices denoted device A, 616, device B, 617, and device C, 618. For this embodiment, the content data downloaded to subscriber 606c is delivered to one or more devices according to predefined rules and may be modified according to the type of device that the content is ultimately directed to. For example, if device A, 616 is a cellular phone with a limited display capacity, the downloaded data object may comprise text data only, rather than graphics which are unable to be adequately displayed by the phone display.

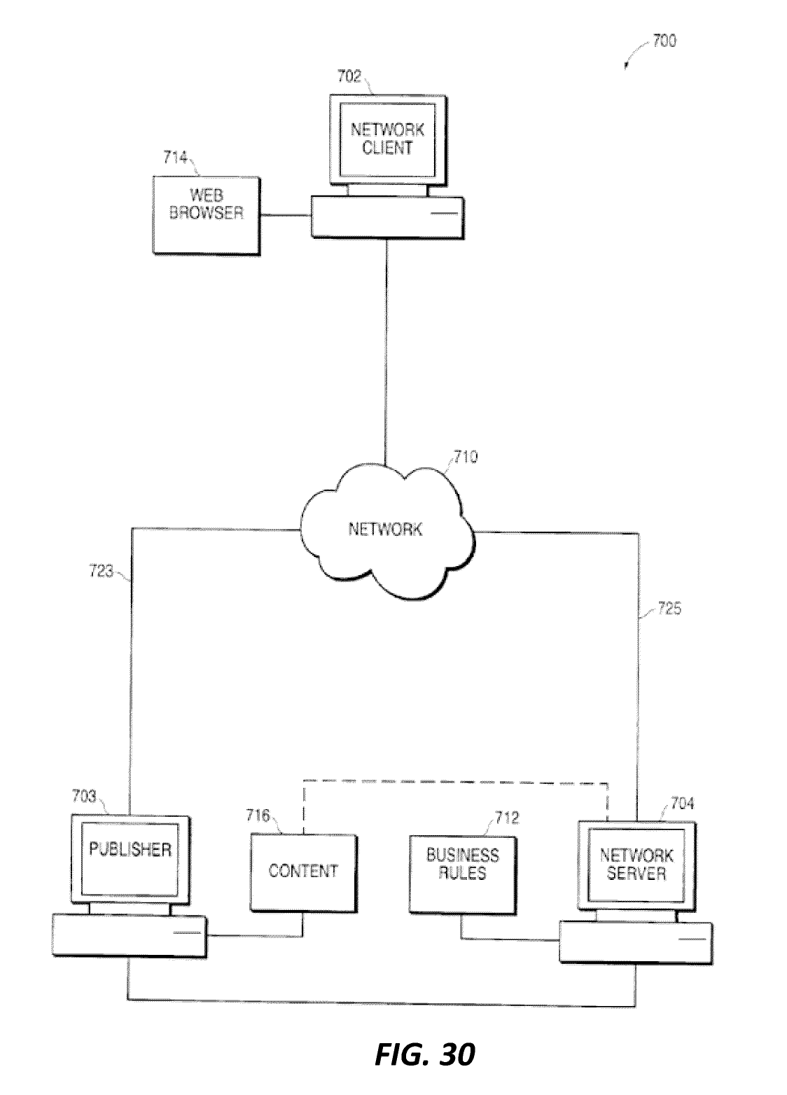

FIG. 30 is a block diagram of a computer network system that can be used to implement an object delivery and billing system, according to one embodiment of the present invention. The system 700 of FIG. 30 is a simplified illustration of a distributed electronic commerce system that can implement aspects of the present invention.

In system 700, a publisher computer 703 is coupled, directly or indirectly, to one or more network client computers 702 through a network 710. The network interface between publisher computer 703 and client computer 702 may also include one or more routers. The routers serve to buffer and route the data transmitted between the server and client computers. Network 710 may be the Internet, a Wide Area Network (WAN), a Local Area Network (LAN), intranet, extranet, wireless network, or any combination thereof, or any packet-based network. The network client 702 represents a computer or computing device operated by a subscriber, such as subscriber 606 in FIG. 29A.

The publisher computer 703 contains, or is coupled to a content data store 716. The publisher 703 makes this content available to the subscriber network client 702 over the network 710 in response to a download or purchase request from the subscriber, or in response to a predetermined event or time duration, such as an automatic periodic (e.g., daily) download. The content data is transmitted in the form of data objects, that represent digital media product that is either paid for by the subscriber or that otherwise constitutes part of a revenue bearing event that requires ultimate payment to the publisher 703. The business model that dictates the transmission of the data objects and payment for these objects may be maintained by a set of business rules defined and processed by the publisher 703. Payment from the subscriber to the publisher may be facilitated or accomplished through the use of a third party billing system or financial entity that may also be coupled to network 710, such as billing system 612 illustrated in FIG. 29A.

The embodiment illustrated in FIG. 30 includes a network server 704 that is coupled to network 710. Network server 704 represents an intermediate server 608, shown in FIG. 29D, that may serve to aggregate content data from one or more publishers 703. In this manner, the network server 704 may be directly or indirectly coupled to the content 716 that is provided by the publisher 703. The network server 704 accesses business rules 712 that dictate the transmission of the content from the publisher 703 to the subscriber 702. These business rules 712 may also include routing and tracking processes that serve to direct the content data to the appropriate subscriber device or application program, as well as billing processes that facilitate payment from the subscriber to the publisher. In one embodiment of the present invention, the network 710 and the network server 704 together constitute a portion of the switching network 604 illustrated in FIG. 29A.

Although FIG. 30 illustrates the various computers coupled to network 710 as client or server computers, it should be noted that the publisher and subscriber network entities can be implemented in any type of network computing device that is capable of performing client and/or server functions when coupled to a network. Moreover, network 710 may be a public network in which any publisher can access the network, and similarly any user or application can access the network. Such a network could be a public wide or local area network, or it could be the Internet, or a network that runs alongside the Internet.

In one embodiment of the present invention, the publisher 703 and/or network server 704 are implemented as a World-Wide Web (WWW) servers that store data in the form of ‘Web pages’ and transmit these pages as Hypertext Markup Language (HTML) files over the Internet network 710 to the one or more of the client computers 702. For this embodiment, the client computer 702 runs a “Web browser” program 714 to access the Web pages served by publisher 703. For this embodiment, network server 704, or a similar server within network 710 may include a Web adapter that facilitates the routing and switching of the data objects embodying the Web pages or HTML data to the appropriate subscribers. This data object switch process comprises the content delivery and billing system described in relation to the network implementation illustrated in FIGS. 29A-29E.

In an alternative embodiment, communication among the various server and client computers is not implemented via a Web-based interface. For example, content data, such as rich media files can be transmitted to a non-PC device that does not execute a Web browser program. Such data can be transmitted to a particular application program that interprets the data.

For the system illustrated in FIG. 30, the server computer 704 may include an account managing process that stores data relevant to commercial transactions with various subscribers network clients 702. The server 704 can provide access to a database of available content data, products and/or services that can be purchased by subscribers (customers). Such a database may be available locally on server 704 or through the publisher 703. In this case, the link between publisher 703 may be a direct link to server 704, or it may be in indirect link through network 710. The business rules 712 maintained by either the publisher or server 704 to evaluate the purchase requests from the subscribers and provide content in response to a request or download of content data. The server and/or publisher may also store account information regarding the identity, billing history, shipping information, and other information regarding each customer. New customers have the opportunity to set up client accounts maintained by the server to establish a billing structure to manage their transactions. Suppliers of the content objects (i.e., other publishers) may also have the opportunity to set up accounts to manage the billing process, set prices and payment terms, and so on.

In one embodiment of the present invention, server 704 in network system 700 includes a data delivery process that is configured to handle data download requests or product orders from a customer. For this embodiment, the publisher 703 publishes or posts the content data to the network server 704 or other server within the switching network. The network server then distributes the content data to the appropriate subscribers. It should be noted, that the term “data” or “product data” refers generically to any type of content, data object, or collection of data transmitted among the client and server computers, and that is considered revenue bearing data or content that is part of a greater overall financial relationship between the publisher and subscriber.

In one embodiment of the present invention, the network server 704 makes up part of the switching network between the subscribers and publishers. Delivery of content data from a publisher to a subscriber may be explicitly requested by a subscriber, such as through a “purchase” command provided on an interface screen or Web page. Alternatively, the content data may be delivered automatically to a subscriber upon the occurrence of a predetermined event, such as a weekly or daily subscription service, e.g., receiving stock quotes hourly or daily. The server 704 maintains rules and filters that dictate the transmission of data from the publishers to the subscribers based on the identification of the subscribers, the payment for the data, and/or the occurrence of the predetermined events. Typically, upon a download request or event, the content product is parsed into its principal component objects. These objects thus include information that specifies the identity of the requestor and the type of device that the customer is using (client computer device). The business logic that specifies the type of business rule or rules that are to be applied to the transaction request reside on either the publisher or network server computer, or on the subscriber client computer at the application level.

The client computer that is utilized by a customer can be one of a number of different network computing devices, including Web-based Internet devices, such as a standard personal computer, a Web-enabled cell phone, a personal digital assistant (PDA) device, a network appliance (“toaster”) device, or any similar type of client computing device. In some cases, the client computer may execute an application that automatically requests the data without the need for user input or intervention.

Aspects of the data object delivery and data transaction model utilized in embodiments of the present invention are described in the above-referenced U.S. patent application, entitled “Method and System for Continuous Interactive Communication in an Electronic Network”, that is assigned to the assignee of the present application, and that is hereby incorporated by reference. For this embodiment, the interface between the customer client computer 702 and the publisher 703 is accomplished through an intermediate communications platform that includes a network server 604 that forms part of the switching network.

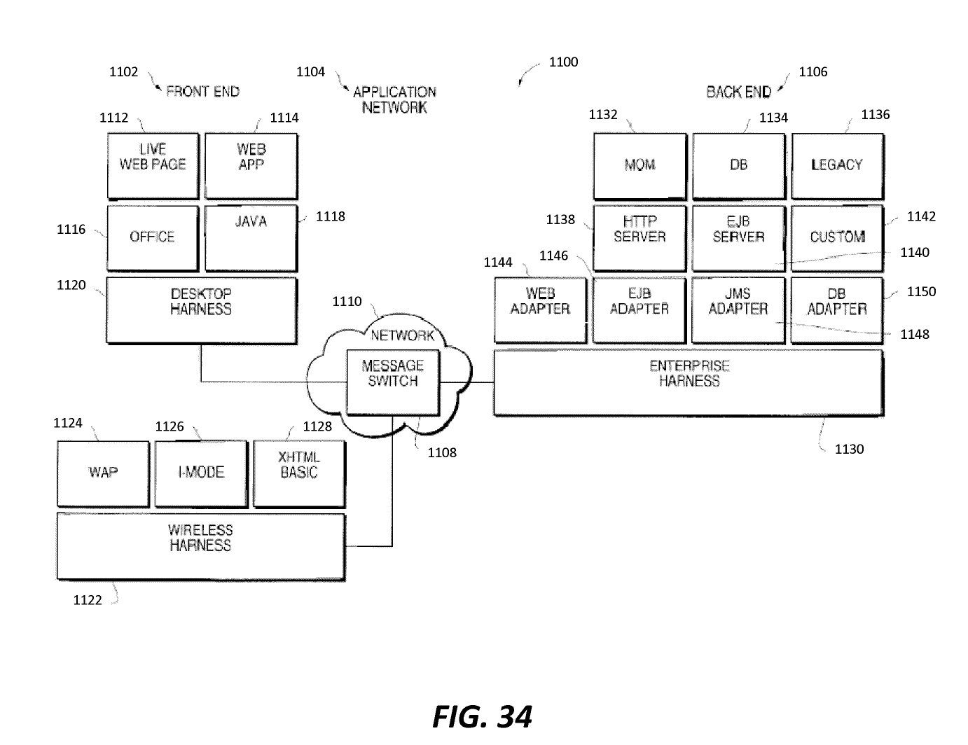

FIG. 34 illustrates a network architecture that can be used to implement the data distribution and billing methods according to embodiments of the present invention. The network architecture illustrated in system 1100 comprises the three major components of a front end 1102, application network 1104, and a back end 1106. The front end 1102 represents a user client device, client computer, PDA, cell phone, or other type of networked computing device. Hardwired client devices are coupled to the network 1110 through a desktop harness 1120 that provides an interface to various client processes, such as Web browser pages 1112, Web applications 1114, Java interface 1118 or Office or other program interfaces 1116. Wireless client devices (e.g., cell phones or PDA's) couple to network 1110 through a wireless harness 1122. The wireless harness 1122 provides access various wireless application programs, such as WAP 1124, I-mode 1126, and XHTML basic processes 1128.

The desktop harness 1120 includes an interface with defined connectors that allows the front end to connect to network 1110. Similarly, the enterprise harness 1130 includes an interface with defined connectors that allows the back end to connect to network 1110.

The back end 1106 component of system 1100 represents the system associated with the content providers and/or publishers. This component comprises an enterprise harness 1130 that couples the network 1110 to various back end processes, servers and databases. These include, but are not limited to, an HTTP server 1138, EJB server 1140, as well as custom servers 1142. These servers access various databases and legacy objects 1132, 1134, and 1136. The backend 1106 also includes various adapters, such as Web adapter 1144, EJB adapter 1146, JMS adapter 1148, and database adapter 1150.

The client front end 1102 and publisher/content provider back end 1106 systems are coupled through application network 1104 that is built on network 1110. This network includes a message switch 1108 that routes content to the client devices using various parameters, such as device type, client (user) identification, data type, topic, and so on. The application network 1104 includes several processes and functions that enable aspects of the present invention. These include a store and forward function that allows the client device to access data from the back end servers, as well as conduct transactions with these servers without requiring a live network connection at the time the transaction is initiated or received/accepted. The application network also processes the transmitted data objects on a granular level that allows intelligent routing through the message switch 1108. This allows for dynamic routing of the data depending upon the parameters listed above, as well as multiplexing of data from various servers to a single client device, or devices assigned to a single user. It also allows for multiplexing of content requests from multiple users to a single publisher or group of publishers. The granularity function breaks the data objects down into component parts and provides a message header for each component for arbitrary data payloads. That is, the data payload can be in any type of format, e.g., text, video, voice, and so on. The message switch can then route the data to the appropriate client through an addressing scheme that differentiates by user ID, topic, and device type. Details of these aspects of the present invention are provided in greater depth in the above-referenced U.S. patent entitled “Method and System for Continuous Interactive Communication in an Electronic Network”.

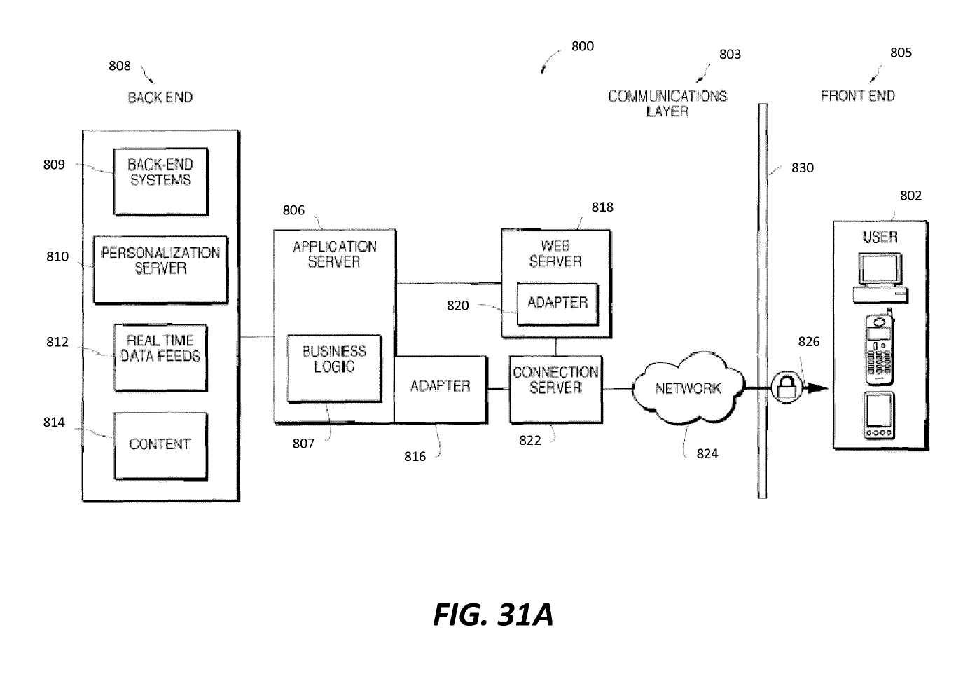

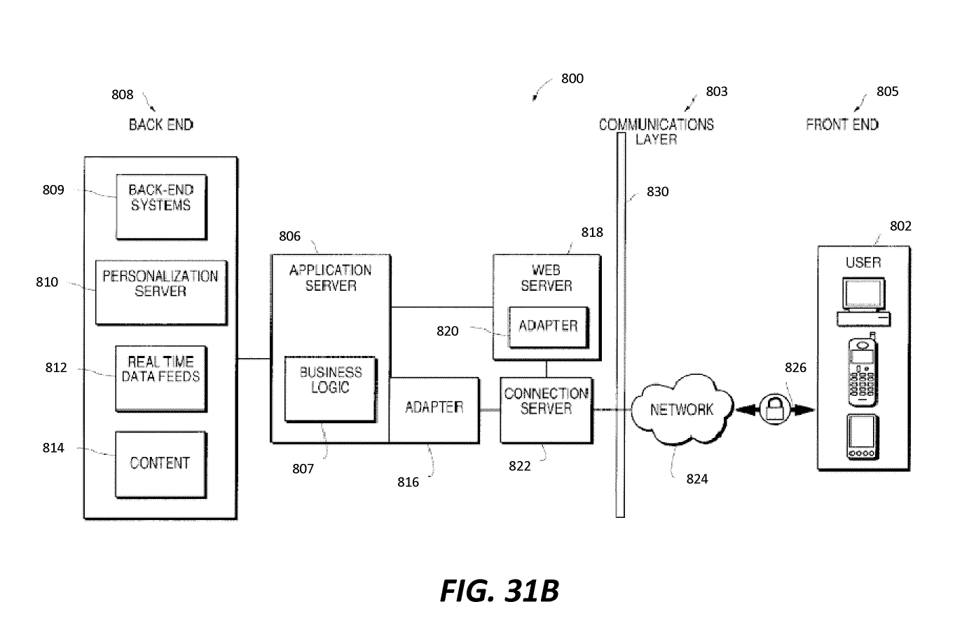

FIG. 31A illustrates a communications platform based client-server network system that can be used to implement a data object delivery and billing system, according to one embodiment of the present invention, whereby the switching network is delivered as a service hosted by a third party entity. For the embodiment illustrated in FIG. 31A, the switching network is delivered a packaged product to entities who want to deploy their own data object content delivery and billing network. The system illustrated in FIG. 31A illustrates a data distribution and bill processing instance of the generic architecture illustrated in FIG. 34. System 800 comprises the three main components of back end 808 coupled to front end 805 through a communications layer 803. The front end 805 comprises a user client computing device that may be a personal computer, PDA, cell phone, or any other type of internet-enabled client device.

The back end component 808 comprises the back end systems 809 associated with the content provider or publisher servers. These include personalization server 810, real time data feeds 812, and content 814. The back end 808 also includes an application server 806 that, in turn, includes several server processes, such as business logic process 807. In one embodiment, the application server 806 is coupled to a Web server process 818 that includes an adapter 820. The application server may also include or be coupled to other adapters 816, depending upon the actual implementation, this may include an EJB adapter. The Web adapter and/or EJB adapter are coupled to the network 824 through a connection server 822.

For embodiments in which the network connection is over the Web, connection between the application server 806 and the front end is through Web server 818. Adapter 820 couples Web server 818 to the network 824 via connection server 822. For embodiments in which the network connection is over a different protocol, the application server is coupled to the front end through connection server 822. The connection server may then be directly coupled to the network 824.

The communications layer 803 comprises the appropriate network protocols to allow communication between the client front end 805 and the server back end 808 over network 824. The communications layer allows secure (locked) communications over any network link 826. For example, the communication link 826 may be implemented as an IP/HTTP link. For the embodiment illustrated in FIG. 31A, a firewall 830 is provided between the network 824 and the front end 805 client devices 802.

As stated above with reference to FIG. 34, the communication platform that couples the user 802 to the application server 806 includes several processes that support full interactivity and continuous availability in communications between the user (subscriber) and application server in the client/server or client/client network. The application server can send data to the client computer at any time, with no need to wait for user requests. The server and end user device can communicate at any time. The user need not be executing an active Web browser application to access the server, and the server can download content to the user(s) at any time. The communication platform also includes an error checking process that executes error check procedures, data transfer retries, and error correction processes to overcome network communication problems. The communication platform incorporates a Store and Forward messaging infrastructure to provide event-driven delivery of objects between application elements. Objects are given to the system for delivery to a specified address or group of addresses. They are accepted and stored until delivery is possible. Upon delivery, they are passed immediately onto the appropriate destination application element. Objects can be transformed from one representation to another within the messaging infrastructure, if requested by the sender or recipient.

FIG. 31B illustrates a communications platform based client-server network system that can be used to implement an object delivery and billing system, according to one embodiment of the present invention. For the embodiment illustrated in FIG. 31A, the object delivery and billing network is assumed to be delivered as a hosted third party service. The system illustrated in FIG. 31B is essentially identical to that illustrated in FIG. 31A except for the functional location of the firewall 830, which is placed between the communication layer 803 and the back end 808. Distribution of the data as a product, as illustrated in FIG. 31B may be provided in situations in which third parties desire to purchase and implement a message switching and billing service as part of their own service or as part of an internal network.

In a comprehensive distributed network with several content providers and client device users, the users may purchase and access data from one or more content providers. The back end component 808 comprising the back end systems 809, the application server 806 and the Web or connection servers 818 and 822 represent the key components for each content provider. The back end and front end components 808 and 805 are considered to be network nodes on the communication platform. Content data can be routed between any node. In this manner, content originating from one client can be routed through the switching network to another client and/or application. A user may access different types of data from various content providers, for example audio content from an audio content provider (e.g., an on-line radio Web site) and video from a video content provider (an on-line TV station Web site). In one embodiment, this transaction is managed by a data distribution management server that is embodied within the communications layer 803 (switch). This data distribution management server can package the content for distribution to the client device and aggregate the billing price for the content, as well as manage payment from the user to the content providers based on tracking that is associated with the switch. The granular feature of the communications layer allows for intelligent routing of the data from the content providers to the client device, either directly or through the data distribution management server. Likewise, the store and forward feature of the data distribution management server allows the content providers to publish the content to the network regardless of the connection status of the client device. Using a store and forward queue, the user can access the published data once the user logs onto the network through the client device.

FIG. 30 represents a generalized network diagram in which the product or content data 716 is provided by a separate publisher 703. The publisher server 703 represents a content provider that is ultimately responsible for providing the requested content to the customer. As mentioned previously, the data may be explicitly requested from the customer, or it may be requested by an automated process that responds to a predetermined event, such as a date/time trigger. The network server 704 executes a download of requested content from the contents database 716 that is stored internally or externally to the publisher server 703. Along with processing requests for downloading of content data, the network server 704 may also retrieve the requesting customer data from a customer database and attach it to the requested primary contents or use it to modify content or transmission parameters for particular users. This data is then transmitted from the publisher 703 via the network 710. The network server 704 may be configured to transmit content data to several different customer client computers that have a common product request. For example, such an application can be used to fulfill on-line or hardcopy magazine subscriptions or similar widely distributed periodical products.

In one embodiment of the present invention, wherein network 710 is the Internet, one or both of the servers 703 and 704 execute Web server processes to provide HTML documents to client computers coupled to network 710. To access the HTML files provided by the Web servers, client computer 702 runs a Web client process (typically a Web browser or a portion of browser, such as the HTML rendering engine) 714 that accesses and provides links to Web pages available on the servers and other Internet server sites. In general, the client process may have access to any type of data and business processes available on the publisher 703 or network server 704. It should be noted that a network system 700 that implements embodiments of the present invention may include a larger number of interconnected client and server computers than shown in FIG. 30. Moreover, system 700 in FIG. 30 anticipates larger interconnected network systems in which multiple client computers are coupled to one another and multiple server computers are coupled to one another.

The network 710 is normally a bi-directional digital communications network that connects the user's terminal hardware with the data distribution management server provided on the server side of the system. Some examples of existing network infrastructures include CATV (cable television) bi-directional network, ISDN (Integrated Services Digital Network), DSL (Digital Subscriber Line), or xDSL high-speed networks.

For purposes of the following description, the term “customer” includes any party that consumes data within the transaction system 700, and the term “content” includes revenue bearing data (e.g., ‘for pay data’ or data provided as part of a broader financial relationship) delivered across the system 700. In some cases, a customer can also be a publisher. System 700 is a simplified diagram of an aggregated marketplace of publishers and consumers. The term “content data” in the context of the specification and claims shall be understood to refer to any type of downloadable data, which may consist of any one of text data, video linear streaming data, such as motion picture data in MPEG or MPEG2 format; linear audio streaming data, such as music data in MP3 format; binary program data; voice data; or any combination of such data or similar data. In general, content data does not include services or data that are used solely to provide access to a network, such as browser software or protocol handlers whose main function is only to establish a network connection.

The system of FIG. 30 allows the implementation of an entire billing system across a WAN (Internet or other Wide Area Network) whereby a publisher can bill an end user or customer based on consumption of content at a very granular level. Such a granular level includes a description of the content type, customer parameters (e.g., location, purchase history, preferences, credit rating, and so on), and customer client computer device type, even in real time. A publisher can be any entity that provides content to one or more customers. The content could be any electronic data that is transmitted to the client computer over the network 710. Alternatively, the content could be non-electronic products or services that the publisher causes to be delivered to the user upon successful completion of the purchase transaction.

A publisher can dynamically create content from multiple sources and aggregate billing in real-time. For example, a publisher could obtain music content data from a first company and associated review information from a second company, and then combine the product offering to the customer with an aggregated billing statement. The publisher may have different credit terms for each of companies, for example, payment is not forwarded to the second company until 30 days after consumption and 60 days for the first company. The billing platform within the business rules of the network server 704 can be configured to recognize this. The billing system can also be configured to allow the publisher to sell content to the customer, and have the customer agree to and pay for its consumption (offline) at one time, and deliver that content at another time.

In one embodiment, a publisher, or other entity on the network, provides a Web-based interface that allows self-publication of available contents and a definition of the granular level access rights to that content across the network. For example, the interface will display certain requirements and restrictions, such as, age restrictions, payment terms, and so on. The interface could also allow tiered pricing structures and tiered service level agreements on a customer, content topic, or device level. For example, signing up for the same news alerts could carry different pricing regimes depending upon the user's client device. For instance, if the subscribed product is periodical news information, and the user receives the data on a personal computer, the full news stories are transmitted so full fees are charged; on a cell phone only headlines are received, so the fee is reduced. Publishers could also establish pricing regimes based on the publication date of the contents. For example, news headlines may cost consumers 30 cents on the day they are published and only ten cents on the next day, because of the time value of the data. This is achieved by cross-referencing a content time stamp with a database that stores dynamic pricing information for the related content (e.g., x hours after publishing price=$2, x+1 hours after publishing price=$1, and so on).

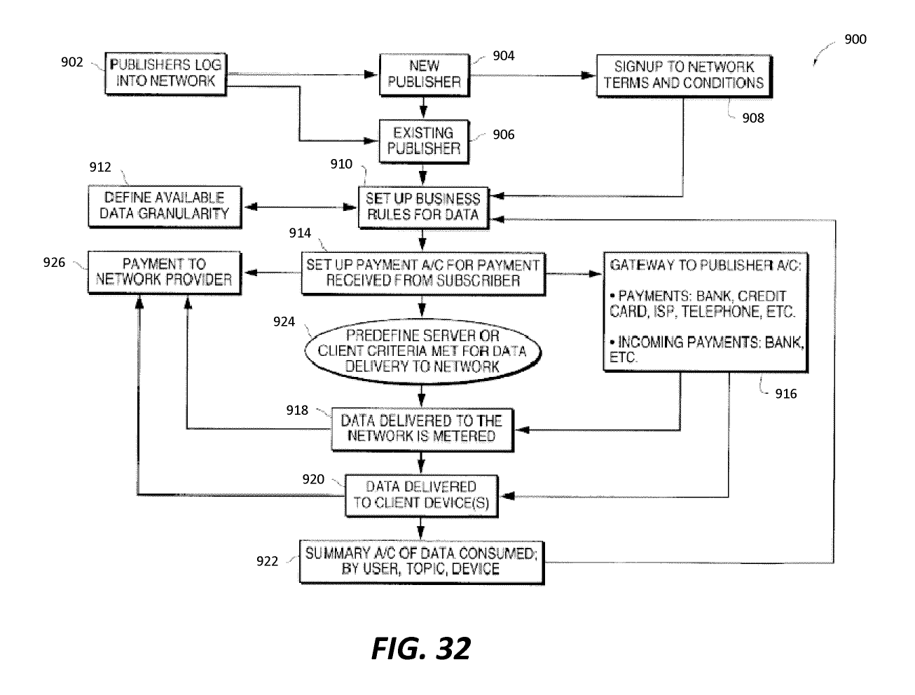

FIG. 32 is a flow diagram that illustrates the publisher-side process for the electronic commerce system of FIG. 30, according to one embodiment of the present invention. For the flow diagram of FIG. 32, a network is established for a number of different publishers. The network allows the publishers to provide content to users and bill the users based on specific usage parameters. In step 902, a publisher logs into the network and it is established whether it is a new 904 or existing 906 publisher. The publisher then signs up to the networks Terms and Conditions, step 908. The publisher then establishes and specifies the relevant business rules for the data, step 910. This can include the price, payment terms, access restrictions, and other data specific information. In step 912, the publisher defines the available data granularity, that can include user identification (age, gender, address, etc), topic, client device, and other user-specific information. It should be noted that there may be different classes of publishers or content providers. For example, one type of publisher (supplier) may only be able to provide certain types or amounts of information, for example headlines from news reports, while other types of publishers may be able to provide an entire range of data.

Once the publisher has set up the business rules, the payment account for money received from the customers is established, step 914. The payment account can be set up in one of several ways, payment to a gateway entity, step 916 or payment from and to the network provider 926. A gateway entity can be a bank or similar financial institution. In this case outgoing payments can be performed using various billing methods or credit instruments, while incoming payments can be provided by a bank or other financial institution. If the payment account is set up with the network server, predefined server or client criteria must first be met for data delivery to the network, step 924. Such criteria may include spending limits, product or service restrictions, customer age restrictions, geographical controls, and so on, either set by the publisher or the customer.

Once the payment account is properly established, the data is delivered to the client device, step 920. In some cases, the data may be transmitted from one client to another client, or between different servers, depending upon the data distribution model. In some instances, publishers may allow data to be shared between the customer's client devices for no additional charge, in other cases additional charges may be incurred. The data delivered to the network is also metered, step 918. Payment is then provided to the network provider, step 926. The publisher may pay the network operator once the data is published to the network, or there may be a tiered payment scheme in which an initial payment is made upon publication to the network with a final payment due when the data is accessed by the end user or client device. As illustrated in FIG. 29A, a gateway may be provided to third party billing services or companies for facilitation of payment transactions.

A summary of the data consumed by user, client device, and so on is collected and made available to the publisher who may use this data to alter the business rules, step 922. Depending upon the implementation details, certain information mapped to an individual user may not be supplied to protect the privacy of users and/or publishers. In this case, arbitrary identifiers may be provided to tag user feedback data. This provides feedback of relevant product and user information so that future transactions can be modified accordingly. Because the network architecture illustrated in FIGS. 30, 31A, and 31B is transactional, there is guaranteed receipt of the digital content, including associated auditing. This feature is useful in identification of problems and dispute resolution. This notification to the publisher of content receipt (or consumption) by the consumer could also occur in real-time at the time of acknowledged receipt or consumption. The metering of data delivered to the network and the reporting of the summary account data facilitates this feature. The billing system could also generate granular reports for publishers allowing them to segment preferred customers and offer them price incentives and bundled offers.

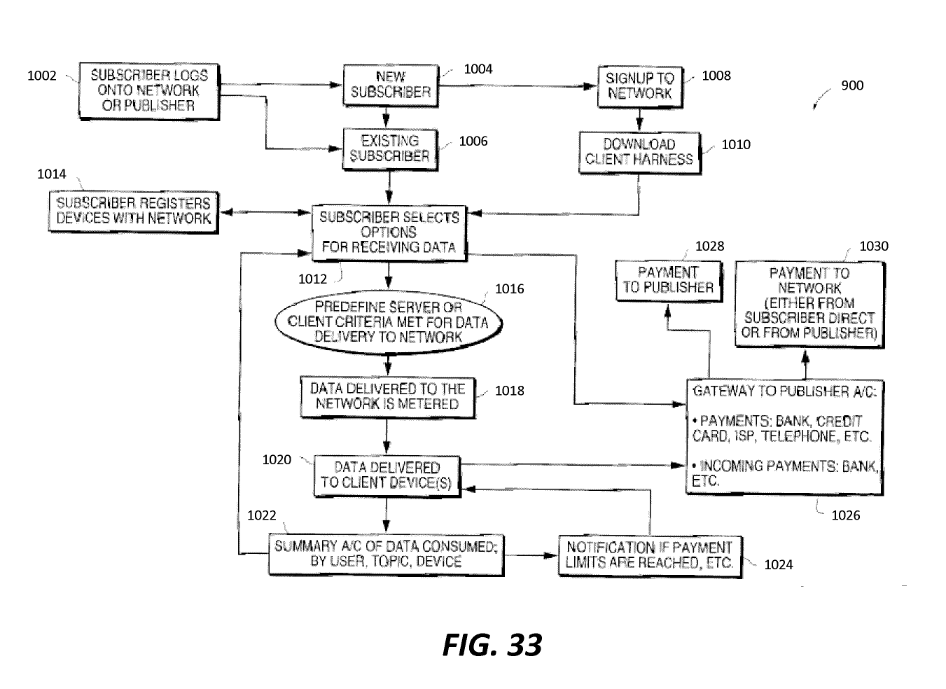

FIG. 33 is a flow diagram that illustrates the subscriber-side process for the electronic commerce system of FIG. 30, according to one embodiment of the present invention. In step 1002, a subscriber (customer) logs into the network and it is established whether it is a new 1004 or existing 1006 subscriber. The subscriber then signs up to the network, step 1008, and downloads a client harness, step 1010. The subscriber then selects options for receiving the data. Such options can include the type of client device to download the contents to (e.g., cell phone, PDA, computer), the appropriate download times, transfer rates, maximum file sizes, and so on, step 1012. This ensures that the billing system is device independent. In step 1012, the subscriber also specifies the payment method he or she would like to use. The subscriber then register the possible client device or devices with the network, step 1014. Previously registered devices may be displayed for selection by the subscriber.

In step 1016, it is determined whether relevant predefined server or client criteria are met for data delivery to the network. In step 1020 the data is delivered to the subscriber's client device, and the delivered data is metered, step 1018. In certain cases, the user can forward the data from one client device to another client device controlled by the user, for example, downloading the data from the user's desktop computer to a laptop computer or PDA. The customer can also set up ‘follow me rules’ for certain data. For example, certain kinds of data might be identified as high priority by the customer. This high priority data is first delivered to one device and then if receipt is not acknowledged it is delivered to another device. Alternatively, if a device is not connected to the network, the data may be delivered to one or more other client devices owned by the customer. The network can be configured to provide digital rights management to ensure that predefined downloads among a single user's client devices is allowed, but downloads among different users is restricted. For example, a user could download a video clip to a set top box and then forward it to their own computer, but would be not permitted to forward it to anyone else's computer.

The payment is then made from the subscriber to the publisher, step 1028 via the network. In some cases, a gateway may be provided through which payment is made, step 1026. For this embodiment, the billing system operator (network) carries no risk or float in acting as an intermediary. The consumer or credit card company carries the risk where appropriate. Payment may also be made directly to the network from the subscriber, step 1030. In step 1022, a summary of the data consumed by the subscriber is registered. If the subscriber has established a particular type of payment account, a notification is issued if payment limits are reached, or if other similar restrictions are met, step 1024.

In one embodiment, the account server that processes the subscriber account and payment information can be configured to allow various processing and filtering functions for the users. For example, customers could link account information for billing, to other applications with instructions to synchronize in real time, this account information whenever there is a change. For example, if a mailing address is changed in a junk mail filter application, this change is reflected in real time in the billing system, and all other predefined, relevant applications as specified by the consumer and the publisher. The customer can be provided with the ability to move money around on the client device with client message store capabilities.

It should be noted that, using the store and forward capabilities of the network system illustrated in FIGS. 31A and 31B, data can be accessed by the user, and payment made for the data objects even when the client device is not connected to the network.

Filters could be established on the client restricting subscription and payment to particular predefined content and publishers, i.e., content type (e.g., content filters to protect children from adult content), size of content file or message, author of content, and so on. Similarly, filters could be established within the network so that customers can receive notification if data objects are available that are outside normal access controls. For example, if a customer has signed up for a subscription that entails monthly payments to access corporate competitive intelligence data, using the network and associated filters, the customer can request a premium corporate credit analysis of a trading partner that is not accessible as part of the subscription, therefore additional payment over and above flat-rate subscription is required before content is delivered. The subscriber account can be configured to allow for multiple billing accounts per device and also the ability to aggregate billing per device, per consumer or for a predefined group of consumers, such as a particular department within a company.

The customer can also set up a filter to halt acceptance of content once a predefined monetary level had been reached for a specified time period. This can be useful for corporate control of purchases of digital assets. Similarly publishers could be configured to notify customers when a predefined limit had been reached. Using the same client side filters, the customer could designate that payment related messages get routed directly to financial management application within the corporation. This prevents the need for personnel, such as the finance department, to re-key any of the transaction related data. Customers could also use filters to determine what other entities, if any, could be given access to transaction details associated with the purchase of contents, or allow limited access to certain transaction records and not other transaction records.

Because the billing system acts as an intermediary, the true identity of the customer could be concealed from the publisher. Anonymity is an important component of monetary systems and is a feature that is absent from many current online payment systems.

In one embodiment, the publisher interface includes a one-click purchase icon to facilitate payment by the subscriber, and to notify the customer that the publisher is part of the billing network. For example, a content delivery and billing network icon can be provided so that the customer knows that the publisher is part of the network and the purchase will automatically be recorded as part of the network. The customer could be notified in real-time of current account balances from the billing network in aggregate (using the billing system), and also of account balances in other predefined accounts. For example, a customer can purchase a book online and click a ‘Buy Now’ icon on the interface. The billing system account balance is then displayed alongside the customer's current credit card account balance and any other financial account balances. This feature allows a consumer to gain complete view of his/her current financial situation when deciding whether or not to make a purchase. Another interface feature could include a currency translator that translates purchase prices from one currency into another in real time, thus informing the consumer what the payment levels will be in the foreign currency.

With reference to FIGS. 29A to 29E, the implementation of a switching network to implement embodiments of the message switching and billing network is typically accomplished through the definition and provision of connectors provided to publishers desiring to connect to the switching network 604. The connectors are provided in the form of one or more interfaces to the network server. The connectors allow the publishers to connect to the switching network through defined network ports. They also help define objects that the switching circuits within the network can recognize. The interfaces provide means by which the publishers can define prices, terms, and conditions of sale, filters, and other parameters pertinent to their content data download service or product. Rules may be defined and maintained by various entities in the network. For example, in FIG. 29D, a first set of rules may be maintained by the publisher 602, a second set of rules may be maintained by the intermediate server 608, and a third set of rules may be maintained by the subscriber 606.

In one embodiment of the present invention, the billing system incorporates various data transmission security schemes, such as digital signature technology and private/public key systems. For this embodiment, the network incorporates various aspects of the security, authentication, and access controls associated with the systems illustrated in FIGS. 31A and 31B.

Although the embodiment illustrated in FIGS. 32 and 33 described aspects of the present invention in the context of a publisher content provider, it should be noted that other types of sellers or content providers are also possible. For example, companies that sell products that are not in computer data form, or that provide services, can also set up billing accounts to provide their products/services to subscribed user.

The data delivery and billing network can also be used for embedded systems. For example, an engine management system in a car may take the form of a publisher, publishing engine status data to the network. Customers of this data may be automotive service companies. Part of the data published by the engine management system may include mechanical repairs required and prices that the owner of the vehicle are willing to pay for these repairs. The automotive service companies could subscribe to this kind of data in accordance with pre-defined rules, e.g., make of car, geographic location, service pricing levels/minimums, and so on. If all criteria are met, the automotive service company could publish interest to the engine management system via the network to perform the repairs. If the pre-defined criteria for the engine management system are met as part of this registered interest on the part of the automotive service company, then a confirmation is sent back to automotive service company and the repairs are scheduled. Alternatively the repairs could be performed automatically if the repairs involve only data, or can be performed remotely via the network.

In the foregoing, a system has been described for transmitting content data and providing billing support among various networked computer users. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method comprising:
displaying on a first device a graphical representation associated with an application;
determining an application type indicating whether the application is executable on the first device, an application provider server, or some combination of the first device and the application provider server;
implementing the application through message-based communication between a client application module executing on the first device and a server application module executing on an application provider server, the application type determining content of messages;
displaying a representation of data on the first device; and
automatically manipulating the data according to the application in response to moving the displayed representation of the data onto the graphical representation of the application.

2. The method of claim 1, wherein automatically manipulating the data according to the application comprises transmitting the data to the first device.

3. The method of claim 2, wherein the data comprises a video file.

4. The method of claim 1, wherein automatically manipulating the data according to the application comprises transmitting the data to an address on a network.

5. The method of claim 1, wherein automatically manipulating the data according to the application comprises transmitting the data to a device represented by the graphical representation.

6. The method of claim 1, further comprising:
transmitting at least some of the data to a storage device that is accessible by both the application provider server and the first device.

7. The method of claim 1, wherein a first of the application types indicates that the application is implemented only on the application provider server.

8. The method of claim 7, wherein a second of the application types indicates that the application is implemented on both the application provider server and the first device.

9. The method of claim 8, wherein a third of the application types indicates that the application is implemented only on the first device.

10. A method comprising:
displaying on a first device a graphical representation associated with an application;
determining an application type indicating whether the application is executable on the first device, an application provider server, or some combination of the first device and the application provider server;
implementing the application through message-based communication between a client application module executing on the first device and a server application module executing on the application provider server, the application type determining content of messages;
providing a bi-directional connection between the first device and at least a second device on an electronic network;
displaying on at least one of the first and second devices an iconic representation of the connection; and
using the iconic representation to transmit the graphical representation between the first device and the second device.

11. The method of claim 10, wherein the iconic representation represents a connection for bi-directionally publishing and receiving messages.

12. A method comprising:
displaying on a first device a graphical representation associated with an application;
determining a type of the application;
implementing the application through communication between a client application module executing on the first device and a server application module executing on an application provider server in accordance with rules associated with the determined application type; and
storing, during an off-line process, a message from the first device associated with the application in a message store comprising at least one non-volatile storage medium accessible to the application provider server.

13. The method of claim 12, wherein the application type indicates whether the application is executable on the first device, the application provider server, or some combination of the first device and the application provider server.

14. A system for communication across an electronic network comprising:
a graphical representation module for displaying on a first device coupled to a network a graphical representation associated with an application;
an application type module configured to determine an application type indicating whether the application is executable on the first device, an application provider server, or some combination of the first device and the application provider server;
an implementation module configured to coordinate message-based communication between a client application module executing on the first device and a server application module executing on the application provider server, the application type determining content of messages; and
a transmitting module for transmitting the graphical representation across the electronic network.

15. A system for communication across an electronic network comprising:
a graphical representation module for displaying on a first device coupled to a network a graphical representation associated with an application, wherein the graphical representation is operable to permit continuous, bi-directional interaction between the application and one or more devices coupled to the network;
an application type module configured to determine an application type indicating whether the application is executable on the first device, an application provider server, or some combination of the first device and the application provider server;
an implementation module configured to coordinate message-based communication between a client application module executing on the first device and a server application module executing on the application provider server;
a first storage module within a bi-directional communications channel for allowing messages to be stored while the first device is offline from the electronic network;
an electronic network management system;
at least one gateway for connecting the electronic network management system to at least one addressable device that is not on the electronic network;
a second storage module accessible to the first device and configured to store messages while the first device is offline from the electronic network;
a third storage module accessible to the first device and configured to store application state data; and
a user management system for managing system and client configurations.
